(19) United States
(12) Patent Application Publication
(10) Pub. No.: US 2020/0131203 A1
(43) Pub. Date: Apr. 30, 2020

(54) ALDOSE REDUCTASE INHIBITORS AND USES THEREOF

(71) Applicant: Applied Therapeutics, Inc., New York, NY (US)

(72) Inventor: Shoshana Shendelman, New York, NY (US)

(21) Appl. No.: 16/607,644

(22) PCT Filed: Apr. 17, 2018
(86) PCT No.: PCT/US2018/027960

§ 371 Date: Oct. 23, 2019

Related U.S. Application Data
(60) Provisional application No. 62/491,243, filed on Apr. 27, 2017.
(60) Provisional application No. 62/501,632, filed on May 4, 2017.

(51) Int. Cl. C07F 5/02

(52) U.S. Cl. CPC C07F 5/025

(57) ABSTRACT

The present invention relates to boronic acid and boronate ester compounds that are inhibitors of aldose reductase, and to compositions that contain the compounds and methods of using the compounds.

### RELATED APPLICATIONS

This application claims the benefit of U.S. Provisional Application No. 62/491,243, filed on Apr. 27, 2017 and the benefit of U.S. Provisional Application No. 62/501,632 filed on May 4, 2017. The entire teachings of the above applications are incorporated herein by reference.

### FIELD OF THE INVENTION

The present invention relates to novel compounds and pharmaceutical compositions thereof, and methods for promoting healthy aging of skin, the treatment of skin disorders, the treatment of cardiovascular disorders, the treatment of renal disorders, the treatment of angiogenesis disorders, such as cancer, treatment of tissue damage, such as non-cardiac tissue damage, the treatment of evolving myocardial infarction, and the treatment of various other disorders, such as complications arising from diabetes with the compounds and compositions of the invention. Other disorders can include, but are not limited to, atherosclerosis, coronary artery disease, diabetic nephropathy, diabetic neuropathy, diabetic retinopathy, infections of the skin, peripheral vascular disease, stroke, and the like.

### BACKGROUND OF THE INVENTION

Diabetes is one of the most common chronic disorders, in which high blood glucose levels result from a lack of insulin production and/or insulin sensitivity. Individuals with high blood glucose metabolize more glucose via glucose to sorbitol to fructose pathway in insulin insensitive cells such as lenses, peripheral nerves and glomerulus. This leads to an overabundance of sorbitol in the cells, which is not easily diffused through the cell membrane. The increased concentration of sorbitol triggers an influx of water into the cells, causing swelling and potential damage.

Aldose reductase, an enzyme present in many parts of the body, catalyzes the reduction of glucose to sorbitol, one of the steps in the sorbitol pathway that is responsible for fructose formation from glucose. Aldose reductase activity increases as the glucose concentration rises in diabetic conditions where tissues are no longer insulin sensitive. These tissues include, for example, lenses, peripheral nerves and glomerulus of the kidney. Sorbitol cannot easily diffuse through cell membranes and therefore accumulates, causing osmotic damage, which in turn leads to retinopathy, neuropathy, and nephropathy. Therefore, inhibition of aldose reductase could prevent the buildup of sorbitol in insulin insensitive cells in diabetics, and presents a novel method to prevent the macrovascular and microvascular complications in diabetic subjects. In addition, aldose reductase inhibitors, such as zopolrestat, may aid in treating or ameliorating such effects and have shown efficacy in wound healing in the corneal epithelium of diabetic animal models.

### SUMMARY OF THE INVENTION

In one aspect, this disclosure relates to compounds of Formula (I)

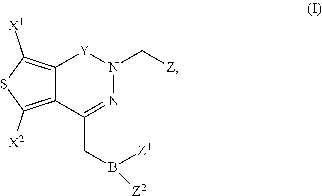

or pharmaceutically acceptable salts, pro-drugs or solvates thereof;
wherein,

X¹ is H or halogen;

X² is H or halogen;

Y is a bond, C═O, C═S, C═NH, or C═N(C₁-C₄)-alkyl;

Z¹ and Z² are independently selected from the group consisting of hydroxy, alkoxy, aryloxy, or Z¹ and Z² taken together with the boron atom to which they are bonded form

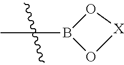

wherein,

X is a substituted or unsubstituted C₂-C₅ alkylene;

Z is

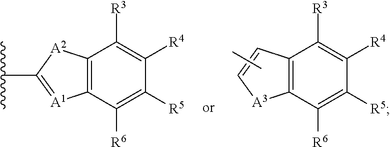

A¹ is NR⁷, O, S or CH₂;

A² is N or CH;

A³ is NR⁷, O, or S;

R³ through R⁶ are independently hydrogen, halogen, cyano, acyl, haloalkyl, haloalkoxy, haloalkylthio, trifluoroacetyl, (C₁-C₄)-alkyl, (C₁-C₄)-alkoxy, (C₁-C₄)-alkylthio, (C₁-C₄)-alkylsulfinyl, or (C₁-C₄)-alkylsulfonyl; and

R⁷ is hydrogen, C₁-C₄ alkyl, or C(O)O—(C₁-C₄)-alkyl.

In another aspect, this disclosure relates to compounds of Formula (II)

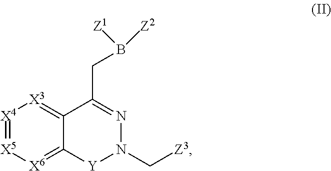

or pharmaceutically acceptable salts, pro-drugs or solvates thereof;
wherein,

X³ is N or CR⁸;

X⁴ is N or CR⁹;

X⁵ is N or CR¹⁰;

X⁶ is N or CR¹¹; with the proviso that two or three of X³, X⁴, X⁵, or X⁶ are N;

Y is a bond, C═O, C═S, C═NH, or C═N(C₁-C₄)-alkyl;

Z¹ and Z² are independently selected from the group consisting of hydroxy, alkoxy, aryloxy, or Z¹ and Z² taken together with the boron atom to which they are bonded form

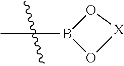

wherein,

X is a substituted or unsubstituted C₂-C₅ alkylene;

Z³ is

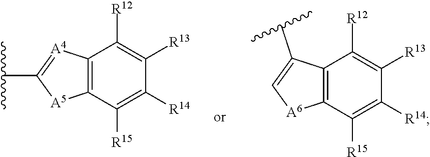

A⁴ is NR¹⁶, O, S or CH₂;

A⁵ is N or CH;

A⁶ is NR¹⁶, O, or S;

R⁸ through R¹⁵ are independently hydrogen, halogen, cyano, acyl, haloalkyl, haloalkoxy, haloalkylthio, trifluoroacetyl, (C₁-C₄)-alkyl, (C₁-C₄)-alkoxy, (C₁-C₄)-alkylthio, (C₁-C₄)-alkylsulfinyl, or (C₁-C₄)-alkylsulfonyl; or two of R⁸ through R¹¹ or two of R¹² through R¹⁵ taken together are (C₁-C₄)-alkylenedioxy; and

R¹⁶ is hydrogen, C₁-C₄ alkyl, or C(O)O—(C₁-C₄)-alkyl.

In one aspect, this disclosure relates to compounds of Formula (III)

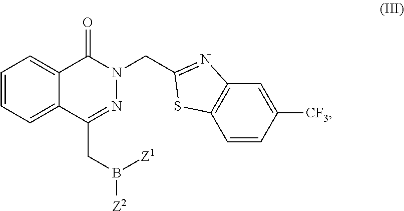

or pharmaceutically acceptable salts, pro-drugs or solvates thereof;
wherein,

Z¹ and Z² are independently selected from the group consisting of hydroxy, alkoxy, aryloxy, or Z¹ and Z² taken together with the boron atom to which they are bonded form

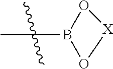

wherein,

X is a substituted or unsubstituted C₂-C₅ alkylene.

Preferably, in compounds of Formula (I), (II) and (III), Z¹ and Z² taken together with the boron atom to which they are bonded form

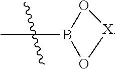

This disclosure also relates to pharmaceutical compositions comprising a compound of Formula (I), (II) and (III), or pharmaceutically acceptable salts, pro-drugs or solvents thereof and to therapeutic methods that comprise administering the compound of Formula (I), (II) and (III), or pharmaceutically acceptable salts, pro-drugs or solvents thereof.

These and other embodiments of the invention are further described in the following sections of the application, including the Detailed Description and Claims. Still other objects and advantages of the invention will become apparent by those of skill in the art from the disclosure herein, which are simply illustrative and not restrictive. Thus, other embodiments will be recognized by the ordinarily skilled artisan without departing from the spirit and scope of the invention.

### DETAILED DESCRIPTION OF THE INVENTION

Aldose reductase inhibitors are described, for example, in U.S. Pat. Nos. 8,916,563; 5,677,342; 5,304,557; 4,954,629; 5,677,342; 5,155,259; 4,939,140; U.S. Patent Publication Application Number US 2006/0293265A1; Roy et al., in Diabetes Research and Clinical Practice, Vol. 10, Issue 1, 91-97; CN101143868A; and Chatzopoulou et al., in Expert Opin. Ther. Pat. 2012, 22, 1303; and references cited therein; each of which hereby incorporated by reference in its entirety. Aldose reductase inhibitors include, for example, zopolrestat, epalrestat, ranirestat, berberine and sorbinil. Boronic acid and boronate ester aldose reductase inhibitors have been discovered and are described herein.

The compounds and/or compositions of the invention may be effective in treating, reducing, and/or suppressing complications related to aldose reductase activity such as, for example, neuropathy, retinopathy, nephropathy, cardiomyopathy, as well as complications in diabetic subjects (e.g., diabetic neuropathy, diabetic retinopathy, diabetic nephropathy, diabetic cardiomyopathy). The compounds and/or compositions of the invention may also be effective in treating, reducing, and/or reducing cardiovascular and renal disorders in non-diabetic subjects, as well as promoting healthy aging of skin or wound healing, amount other uses. Treatment using aldose reductase inhibitors is described in, e.g., CN102512407A; WO 2008/002678A2; CN101143868A; Srivastava et al., in Chem Biol Interact. 2011, 30, 330; Hu et al., in PLoS One 2014, 9(2), e87096; Satoh et al., in J Diabetes Res. 2016, 2016, U.S. Pat. No. 5,383,797; Chatzopoulou et al., in Expert Opin. Ther. Pat. 2012, 22, 1303; each of which is hereby incorporated by reference in its entirety.

### Abbreviations and Definitions

As used herein the term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

The term “acid” contemplates all pharmaceutically acceptable inorganic or organic acids. Inorganic acids include mineral acids such as hydrohalic acids, such as hydrobromic and hydrochloric acids, sulfuric acids, phosphoric acids and nitric acids. Organic acids include all pharmaceutically acceptable aliphatic, alicyclic and aromatic carboxylic acids, dicarboxylic acids, tricarboxylic acids, and fatty acids. Preferred acids are straight chain or branched, saturated or unsaturated C₁-C₂₀ aliphatic carboxylic acids, which are optionally substituted by halogen or by hydroxyl groups, or C₆-C₁₂ aromatic carboxylic acids. Examples of such acids are carbonic acid, formic acid, fumaric acid, acetic acid, propionic acid, isopropionic acid, valeric acid, alpha-hydroxy acids, such as glycolic acid and lactic acid, chloroacetic acid, benzoic acid, methane sulfonic acid, and salicylic acid. Examples of dicarboxylic acids include oxalic acid, malic acid, succinic acid, tataric acid and maleic acid. An example of a tricarboxylic acid is citric acid. Fatty acids include all pharmaceutically acceptable saturated or unsaturated aliphatic or aromatic carboxylic acids having 4 to 24 carbon atoms. Examples include butyric acid, isobutyric acid, sec-butyric acid, lauric acid, palmitic acid, stearic acid, oleic acid, linoleic acid, linolenic acid, and phenylsteric acid. Other acids include gluconic acid, glycoheptonic acid and lactobionic acid.

The term “aldose reductase inhibitor” refers to compounds and salts or solvates thereof that function by inhibiting the activity of the enzyme aldose reductase, which is primarily responsible for regulating metabolic reduction of aldoses. Exemplary aldoses include, but are not limited to, glucose or galactose, and their corresponding polyols, such as sorbitols and galactitols. Exemplary aldose reductase inhibitors may be found in U.S. Pat. Nos. 8,916,563; 5,677,342; 5,155,259; 4,939,140; 4,954,629; and 5,304, 557; U.S. Publication Number US 2006/0293265A1; and Roy et al., in Diabetes Research and Clinical Practice 1990, 10(1), 91-97; and each of which hereby incorporated by reference in its entirety.

The term “alkoxy”, as used herein, refers to —O-alkyl, such as methoxy and the like.

The term “alkyl”, as used herein, unless otherwise indicated, refers to a monovalent aliphatic hydrocarbon radical having a straight chain, branched chain, monocyclic moiety, or polycyclic moiety or combinations thereof, wherein the radical is optionally substituted at one or more carbons of the straight chain, branched chain, monocyclic moiety, or polycyclic moiety or combinations thereof with one or more substituents at each carbon, where the one or more substituents are independently C₁-C₁₀ alkyl. Examples of “alkyl” groups include methyl, ethyl, propyl, isopropyl, butyl, iso-butyl, sec-butyl, tert-butyl, pentyl, hexyl, heptyl, cyclopropyl, cyclobutyl, cyclopentyl, cyclohexyl, cycloheptyl, norbornyl, and the like.

The term “aryloxy”, as used herein, refers to —O-aryl, such as phenoxy and the like.

The term “aryl”, as used herein, refers to a carbocyclic moiety containing at least one benzenoid-type ring, with the aryl groups preferably containing from 6 to 15 carbon atoms, for example, phenyl, naphthyl, indenyl or indanyl.

The term “carrier” refers to a diluent, adjuvant, excipient, or vehicle with which a compound is administered. Non-limiting examples of such pharmaceutical carriers include liquids, such as water and oils, including those of petroleum, animal, vegetable or synthetic origin, such as peanut oil, soybean oil, mineral oil, sesame oil and the like. The pharmaceutical carriers may also be saline, gum acacia, gelatin, starch paste, talc, keratin, colloidal silica, urea, and the like. In addition, auxiliary, stabilizing, thickening, lubricating and coloring agents may be used. Other examples of suitable pharmaceutical carriers are described in Remington's Pharmaceutical Sciences (Alfonso Gennaro ed., Krieger Publishing Company (1997); Remington's: The Science and Practice of Pharmacy, 21^{st} Ed. (Lippincot, Williams & Wilkins (2005); Modem Pharmaceutics, vol. 121 (Gilbert Banker and Christopher Rhodes, CRC Press (2002); each of which hereby incorporated by reference in its entirety).

The term “composition(s) of the invention”, as used herein means compositions comprising a compound of the invention, and salts, pro-drugs, or solvates thereof. The compositions of the invention may further comprise other agents such as, for example, excipients, stabilizing agents, lubricants, solvents, and the like.

The term “compound of the invention”, as used herein means a compound of Formula (I), (II) and (III). The term is also intended to encompass salts, pro-drugs and solvates (e.g. hydrates) thereof.

The term “halogen”, as used herein, means chlorine (Cl), fluorine (F), iodine (I) or bromine (Br).

The phrase “in need thereof” refers to the need for symptomatic or asymptomatic relief from conditions related to aldose reductase activity or that may otherwise be relieved by the compounds and/or compositions of the invention.

The term “method(s) of the invention”, as used herein means methods comprising treatment with the compounds and/or compositions of the invention.

A “pharmaceutical composition” refers to a mixture of one or more of the compounds described herein, or pharmaceutically acceptable salts, pro-drugs or solvates thereof, with other chemical components, such as physiologically acceptable carriers and excipients.

The term “pharmaceutically acceptable salt” is intended to include salts derived from inorganic or organic acids including, for example hydrochloric, hydrobromic, sulfuric, nitric, perchloric, phosphoric, formic, acetic, lactic, maleic, fumaric, succinic, tartaric, glycolic, salicylic, citric, methanesulfonic, benzenesulfonic, benzoic, malonic, trifluroacetic, trichloroacetic, naphthalene-2 sulfonic and other acids; and salts derived from inorganic or organic bases including, for example sodium, potassium, calcium, ammonium or tetrafluoroborate. Exemplary pharmaceutically acceptable salts are found, for example, in Berge, et al. (J. Pharm. Sci. 1977, 66(1), 1; and U.S. Pat. Nos. 6,570,013 and 4,939,140; each hereby incorporated by reference in its entirety). Pharmaceutically acceptable salts are also intended to encompass hemi-salts, wherein the ratio of compound:acid is respectively 2:1. Exemplary hemi-salts are those salts derived from acids comprising two carboxylic acid groups, such as malic acid, fumaric acid, maleic acid, succinic acid, tartaric acid, glutaric acid, oxalic acid, adipic acid and citric acid. Other exemplary hemi-salts are those salts derived from diprotic mineral acids such as sulfuric acid. Exemplary preferred hemi-salts include, but are not limited to, hemimaleate, hemifumarate, and hemisuccinate.

A “pro-drug” refers to an agent which is converted into the parent drug in vivo. Pro-drugs are often useful because, in some situations, they are easier to administer than the parent drug. They are bioavailable, for instance, by oral administration whereas the parent drug is either less bioavailable or not bioavailable. The pro-drug also has improved solubility in pharmaceutical compositions over the parent drug. For example, the compound carries protective groups which are split off by hydrolysis in body fluids, e.g., in the bloodstream, thus releasing active compound or is oxidized or reduced in body fluids to release the compound. The term “pro-drug” may apply to such functionalities as, for example, the boronic acid functionalities of the compounds of Formula (I), (II) and (III). Pro-drugs may be comprised of structures wherein a boronic acid group is masked, for example, as a boronate ester. Further examples of pro-drugs are discussed herein and, for example, by Alexander et al., J. Med. Chem. 1988, 31, 318 (hereby incorporated by reference in its entirety).

The term “solvate”, as used herein means a compound, or a pharmaceutically acceptable salt thereof, wherein molecules of a suitable solvent are incorporated in the crystal lattice. A suitable solvent is physiologically tolerable at the dosage administered. Examples of suitable solvents are ethanol, water and the like. When water is the solvent, the molecule is referred to as a “hydrate”.

As used herein, the term “subject” encompasses mammals and non-mammals. Examples of mammals include, but are not limited to, humans, chimpanzees, apes monkeys, cattle, horses, sheep, goats, swine, rabbits, dogs, cats, rats, mice, guinea pigs, and the like. Examples of non-mammals include, but are not limited to, birds, fish and the like.

A “therapeutically effective amount”, as used herein is an amount of a compound that is sufficient to effect beneficial or desired results, including clinical results. As such, the therapeutically effective amount may be sufficient, for example, to reduce or ameliorate the severity and/or duration of afflictions related to aldose reductase, or one or more symptoms thereof, prevents the advancement of conditions or symptoms related to afflictions related to aldose reductase, or enhance or otherwise improve the prophylactic or therapeutic effect(s) of another therapy. A therapeutically effective amount also includes the amount of the compound that avoids or substantially attenuates undesirable side effects.

As used herein and as well understood in the art, “treatment” is an approach for obtaining beneficial or desired results, including clinical results. Beneficial or desired clinical results may include, but are not limited to, alleviation or amelioration of one or more symptoms or conditions, diminution of extent of disease or affliction, a stabilized (i.e., not worsening) state of disease or affliction, preventing spread of disease or affliction, delay or slowing of disease or affliction progression, amelioration or palliation of the disease or affliction state and remission (whether partial or total), whether detectable or undetectable. “Treatment” can also mean prolonging survival as compared to expected survival if not receiving treatment.

In the formulas described herein, the haloalkyl, haloalkoxy, haloalkylthio groups can contain one or more halogen, which can be the same or different as desired.

In one aspect, this disclosure relates to aldose reductase inhibitors of Formula (I)

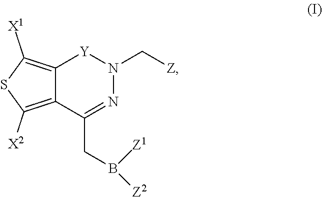

or pharmaceutically acceptable salts, pro-drugs or solvates thereof;
wherein,
X¹ is H or halogen;
X² is H or halogen;
Y is a bond, C═O, C═S, C═NH, or C═N(C₁-C₄)-alkyl;
Z¹ and Z² are independently selected from the group consisting of hydroxy, alkoxy, aryloxy, or Z¹ and Z² taken together with the boron atom to which they are bonded form

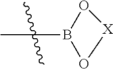

wherein,
X is a substituted or unsubstituted C₂-C₅ alkylene;

Z is

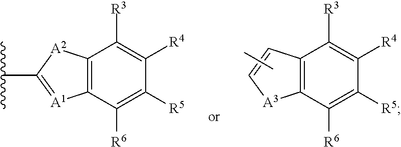

A¹ is NR⁷, O, S or CH₂;

A² is N or CH;

A³ is NR⁷, O, or S;

R³ through R⁶ are independently hydrogen, halogen, cyano, acyl, haloalkyl, haloalkoxy, haloalkylthio, trifluoroacetyl, (C₁-C₄)-alkyl, (C₁-C₄)-alkoxy, (C₁-C₄)-alkylthio, (C₁-C₄)-alkylsulfinyl, or (C₁-C₄)-alkylsulfonyl; and

R⁷ is hydrogen, C₁-C₄ alkyl, or C(O)O—(C₁-C₄)-alkyl.

Suitable substituents on the C₂-C₅ alkylene include one or more alkyl, alkoxy, aryl, aryloxy, halo, haloalkyl, haloalkoxy, haloalkylthio. A preferred substituted C₂-C₅ alkylene is substituted ethylene. A more preferred substituted C₂-C₅ alkylene is —C(CH₃)₂C(CH₃)₂—.

It will be recognized by those of skill in the art that the designation of

Z is

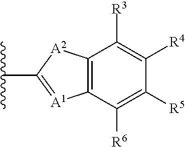

### or Z is

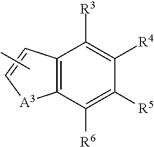

indicates that when Z is

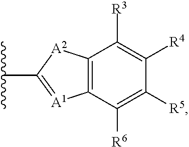

the compounds of Formula (I) are understood to encompass

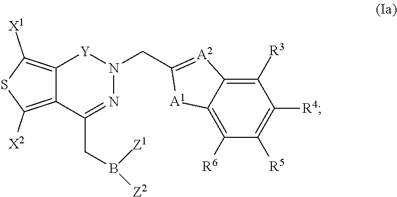

and
when Z is

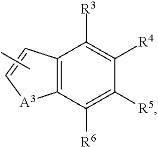

the compounds of Formula (I) are understood to encompass

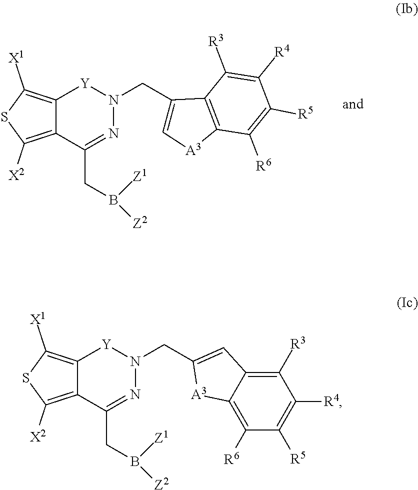

wherein,

Z¹ and Z² are independently selected from the group consisting of hydroxy, alkoxy, aryloxy, or Z¹ and Z² taken together with the boron atom to which they are bonded form

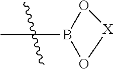

wherein,

X is a substituted or unsubstituted C₂-C₅ alkylene.

In certain embodiments, R³ through R⁶ of Formula (I) are independently hydrogen, halogen, cyano, acyl, haloalkyl, haloalkoxy, haloalkylthio, trifluoroacetyl, (C₁-C₄)-alkyl, (C₁-C₄)-alkoxy, (C₁-C₄)-alkylthio, (C₁-C₄)-alkylsulfinyl, or (C₁-C₄)-alkylsulfonyl.

In certain embodiments, R³ through R⁶ of Formula (I) are independently hydrogen, halogen or haloalkyl. In certain embodiments, R³ through R⁶ are independently hydrogen, halogen or trihaloalkyl.

In certain embodiments, R³ and R⁶ of Formula (I) are hydrogen. In certain embodiments, R³, R⁵, and R⁶ are hydrogen.

In certain embodiments, R⁴ of Formula (I) is hydrogen, halogen or haloalkyl. In certain embodiments, R⁴ is hydrogen. In certain embodiments, R⁴ is halogen. In certain embodiments, R⁴ is haloalkyl. In certain embodiments, R⁴ is CF₃.

In certain embodiments, R³ through R⁶ of Formula (I) are hydrogen. In certain embodiments, R³, R⁵, R⁶ are hydrogen and R⁴ is halogen or haloalkyl. In certain embodiments, R³, R⁵, R⁶ are hydrogen and R⁴ is haloalkyl. In certain embodiments, R³, R⁵, R⁶ are hydrogen and R⁴ is CF₃. In certain embodiments, R³, R⁵, R⁶ are hydrogen and R⁴ is halogen. In certain embodiments, R³, R⁵, R⁶ are hydrogen and R⁴ is F. In certain embodiments, R³, R⁵, R⁶ are hydrogen and R⁴ is Cl.

In certain embodiments, Y of Formula (I) is C═O, C═S, C═NH, or C═N(C₁-C₄)-alkyl. In certain embodiments, Y is C═O or C═S. In certain embodiments, Y is C═O. In certain embodiments, Y is C═S. In certain embodiments, Y is C═NH, or C═N(C₁-C₄)-alkyl.

In certain embodiments, A¹ of Formula (I) is NR⁷, O, S or CH₂. In certain embodiments, A¹ is NR⁷, O, or S. In certain embodiments, A¹ is NR⁷, S or CH₂. In certain embodiments, A¹ is NR⁷ or O. In certain embodiments, A¹ is NR⁷ or S. In certain embodiments, A¹ is NR⁷. In certain embodiments, A¹ is O. In certain embodiments, A¹ is S.

In certain embodiments, A² of Formula (I) is N or CH. In certain embodiments, A² is N. In certain embodiments, A² is CH.

In certain embodiments, A³ of Formula (I) is NR⁷, O, or S. In certain embodiments, A³ is O. In certain embodiments, A³ of Formula (III) is S. In certain embodiments, A¹ is NR⁷.

In certain embodiments, X¹ and X² of Formula (I) are hydrogen.

In certain embodiments, X¹ and X² of Formula (I) are halogen. In certain embodiments, X¹ and X² are Cl.

In certain embodiments, X¹ and X² of Formula (I) are independently hydrogen or halogen. In certain embodiments, X¹ is hydrogen and X² is Cl. In certain embodiments, X¹ is Cl and X² is hydrogen.

In certain embodiments, Z of Formula (I) is

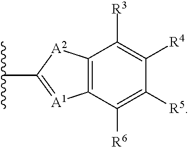

In certain embodiments, Z of Formula (I) is

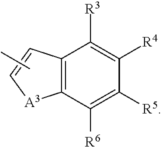

In certain embodiments, R⁷ of Formula (I) is hydrogen, C₁-C₄ alkyl, or C(O)O—(C₁-C₄)-alkyl. In certain embodiments, R⁷ is hydrogen. In certain embodiments, R⁷ is C₁-C₄ alkyl. In certain embodiments, R⁷ is C₁-C₃ alkyl. In certain embodiments, R⁷ is C₁-C₂ alkyl. In certain embodiments, R⁷ is C₁-C₄ n-alkyl. In certain embodiments, R⁷ is C₁-C₃ n-alkyl. In certain embodiments, R⁷ is C(O)O—(C₁-C₄)-alkyl. In certain embodiments, R⁷ is C(O)O—(C₁-C₃)-alkyl. In certain embodiments, R⁷ is C(O)O—(C₁-C₂)-alkyl. In certain embodiments, R⁷ is C(O)O—(C₁-C₄)-n-alkyl. In certain embodiments, R⁷ is C(O)O—(C₁-C₃)-n-alkyl.

In certain embodiments, the compounds of Formula (I) is

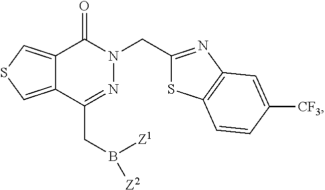

or pharmaceutically acceptable salts, pro-drugs or solvates thereof;
wherein,

Z¹ and Z² are independently selected from the group consisting of hydroxy, alkoxy, aryloxy, or Z¹ and Z² taken together with the boron atom to which they are bonded form

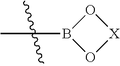

wherein,

X is a substituted or unsubstituted C₂-C₅ alkylene.

In certain embodiments, the compounds of Formula (I) is

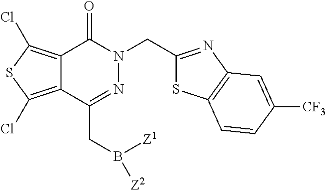

or pharmaceutically acceptable salts, pro-drugs or solvates thereof;
wherein,

Z¹ and Z² are independently selected from the group consisting of hydroxy, alkoxy, aryloxy, or Z¹ and Z² taken together with the boron atom to which they are bonded form

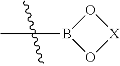

wherein,

X is a substituted or unsubstituted C₂-C₅ alkylene.

In certain embodiments, the compounds of Formula (I) is

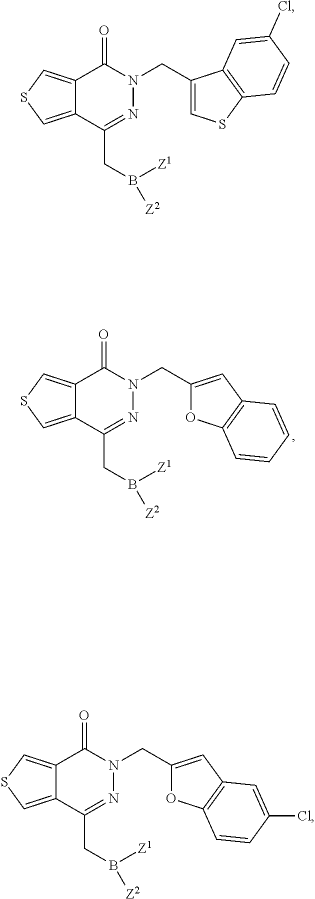

or pharmaceutically acceptable salts, pro-drugs or solvates thereof;
wherein,

Z¹ and Z² are independently selected from the group consisting of hydroxy, alkoxy, aryloxy, or Z¹ and Z² taken together with the boron atom to which they are bonded form

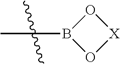

wherein,

X is a substituted or unsubstituted C₂-C₅ alkylene.

In certain embodiments, the compounds of Formula (I) is

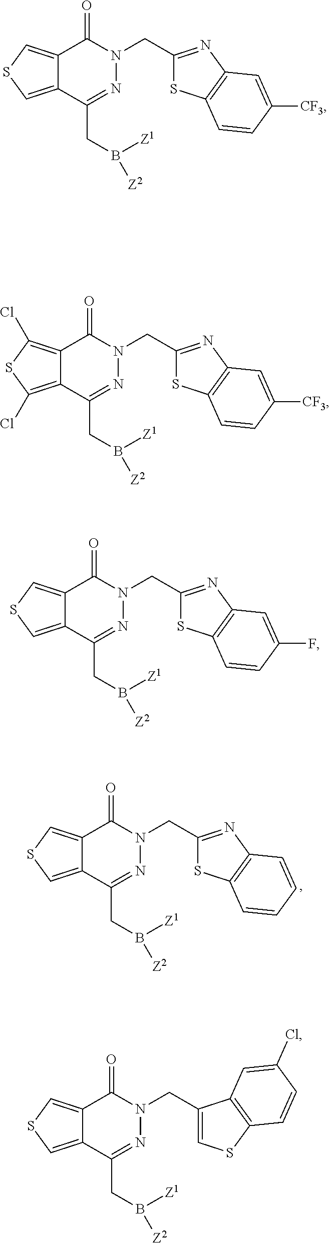

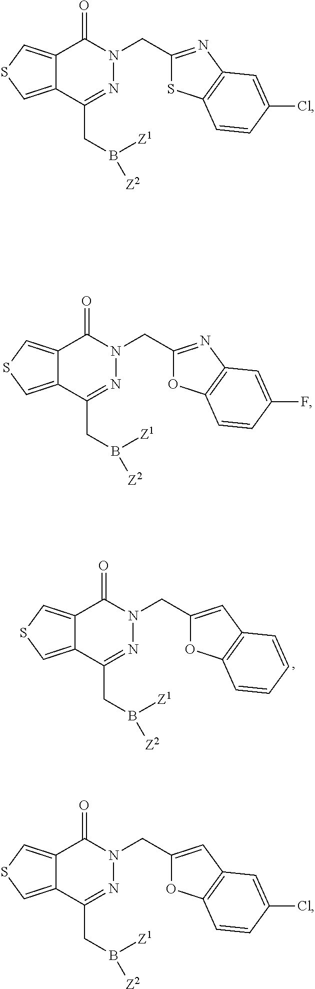

or pharmaceutically acceptable salts, pro-drugs or solvates thereof;
wherein,

Z¹ and Z² are independently selected from the group consisting of hydroxy, alkoxy, aryloxy, or Z¹ and Z² taken together with the boron atom to which they are bonded form

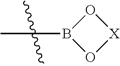

wherein,

X is a substituted or unsubstituted C₂-C₅ alkylene.

In another aspect, this disclosure relates to aldose reductase inhibitors of Formula (II)

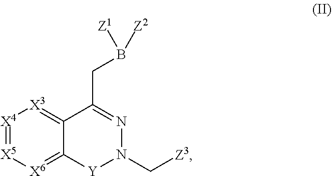

or pharmaceutically acceptable salts, pro-drugs or solvates thereof;
wherein,

X³ is N or CR⁸;

X⁴ is N or CR⁹;

X^{s} is N or CR¹⁰;

X⁶ is N or CR¹¹; with the proviso that two or three of X³, X⁴, X⁵, or X⁶ are N;

Z¹ and Z² are independently selected from the group consisting of hydroxy, alkoxy, aryloxy, or Z¹ and Z² taken together with the boron atom to which they are bonded form

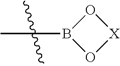

wherein,

X is a substituted or unsubstituted C₂-C₅ alkylene;

Z³ is

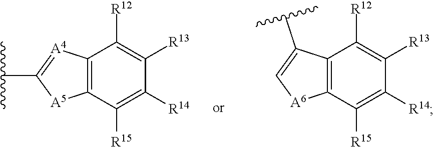

A⁴ is NR¹⁶, O, S or CH₂;

A⁵ is N or CH;

A⁶ is NR¹⁶, O, or S;

R⁸ through R¹⁵ are independently hydrogen, halogen, cyano, acyl, haloalkyl, haloalkoxy, haloalkylthio, trifluoroacetyl, (C₁-C₄)-alkyl, (C₁-C₄)-alkoxy, (C₁-C₄)-alkylthio, (C₁-C₄)-alkylsulfinyl, or (C₁-C₄)-alkylsulfonyl; or two of R⁸ through R¹¹ or two of R¹² through R¹⁵ taken together are (C₁-C₄)-alkylenedioxy; and

R¹⁶ is hydrogen, C₁-C₄ alkyl, or C(O)O—(C₁-C₄)-alkyl.

Suitable substituents on the C₂-C₅ alkylene include one or more alkyl, alkoxy, aryl, aryloxy, halo, haloalkyl, haloalkoxy, haloalkylthio. A preferred substituted C₂-C₅ alkylene is substituted ethylene. A more preferred substituted C₂-C₅ alkylene is —C(CH₃)₂C(CH₃)₂—.

It will be recognized by those of skill in the art that the designation of

Z is

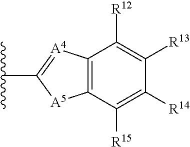

### or Z is

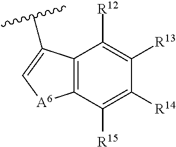

indicates that when Z is

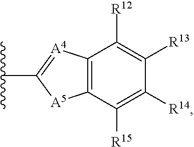

the compounds of Formula (II) are understood to encompass

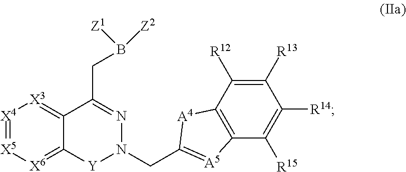

and when Z is

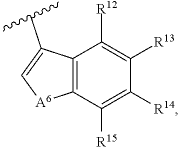

the compounds of Formula (II) are understood to encompass

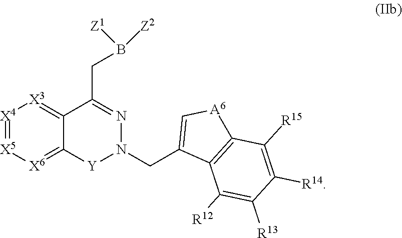

In some compounds of Formula II, R⁸ through R¹⁵ are independently hydrogen, halogen or haloalkyl, for example, R⁸ through R¹⁵ are independently hydrogen, halogen or trihaloalkyl (e.g., —CF₃).

In other compounds of Formula II, R⁸ through R¹¹ are hydrogen.

In certain embodiments of compounds of Formula II, R¹² through R¹⁵ are independently hydrogen, halogen or haloalkyl, for example, R¹² through R¹⁵ are independently hydrogen, halogen or trihaloalkyl (e.g., —CF₃).

In certain embodiments, R¹² and R¹⁵ of Formula (II) are hydrogen.

In certain embodiments, R¹³ of Formula (II) is hydrogen, halogen or haloalkyl. In certain embodiments, R¹³ is hydrogen. In certain embodiments, R¹³ is halogen. In certain embodiments, R¹³ is haloalkyl.

In certain embodiments, R¹⁴ of Formula (II) is hydrogen, halogen or haloalkyl. In certain embodiments, R¹⁴ is hydrogen. In certain embodiments, R¹⁴ is halogen. In certain embodiments, R¹⁴ is haloalkyl.

In certain embodiments, Y of Formula (II) is C═O, C═S, C═NH, or C═N(C₁-C₄)-alkyl. In certain embodiments, Y is C═O or C═S. In certain embodiments, Y is C═O. In certain embodiments, Y is C═S. In certain embodiments, Y is C═NH, or C═N(C₁-C₄)-alkyl.

In certain embodiments, A⁴ of Formula (II) is NR¹⁶, S or CH₂. In certain embodiments, A⁴ is NR¹⁶ or O. In certain embodiments, A⁴ is NR¹⁶ or S. In certain embodiments, A⁴ is NR¹⁶. In certain embodiments, A⁴ is O. In certain embodiments, A⁴ is S.

In certain embodiments, A⁵ of Formula (II) is N or CH. In certain embodiments, A⁴ is N. In certain embodiments, A⁴ is CH.

In certain embodiments, A⁶ of Formula (II) is O or S. In certain embodiments, A⁶ is O. In certain embodiments, A⁶ is S.

In certain embodiments, X³ and X⁶ of Formula (II) are nitrogen.

In certain embodiments, X³ and X⁴ of Formula (II) are nitrogen.

In certain embodiments, X³ and X⁵ of Formula (II) are nitrogen.

In certain embodiments, X⁴ and X⁵ of Formula (II) are nitrogen.

In certain embodiments, X⁴ and X⁶ of Formula (II) are nitrogen.

In certain embodiments, X⁵ and X⁶ of Formula (II) are nitrogen.

In certain embodiments, Z³ of Formula (II) is R¹¹

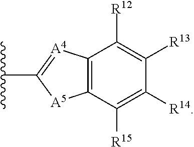

In certain embodiments, Z³ of Formula (II) is

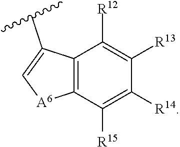

In some embodiments, the compounds of Formula (II) is

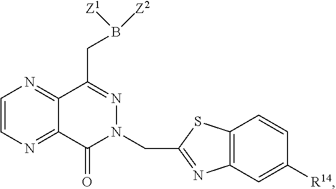

or pharmaceutically acceptable salts, pro-drugs or solvates thereof;
wherein,

R¹⁴ is hydrogen, halogen or trihaloalkyl (e.g., —CF₃); and

Z¹ and Z² are independently selected from the group consisting of hydroxy, alkoxy, aryloxy, or Z¹ and Z² taken together with the boron atom to which they are bonded form

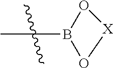

wherein,

X is a substituted or unsubstituted C₂-C₅ alkylene.

In embodiments, the compounds of Formula (II) is

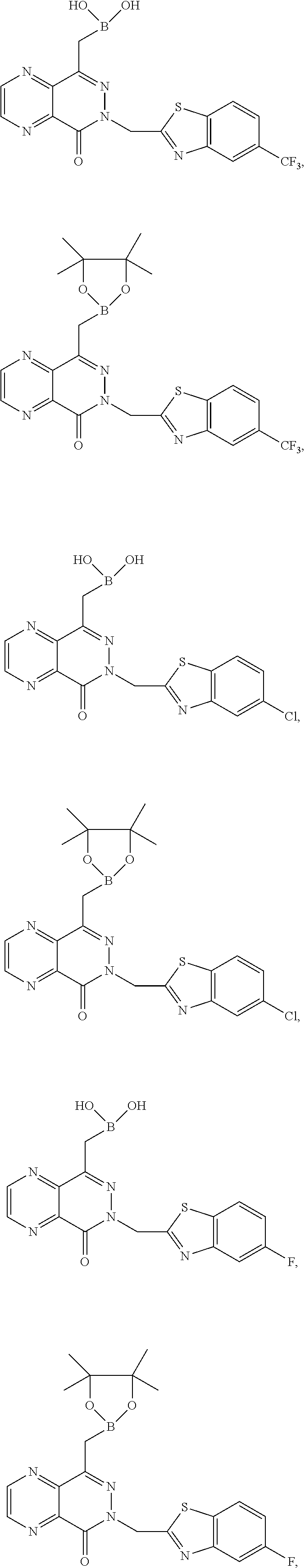 [SMILES: O=c1c2nccnc2c(CB(O)O)nn1Cc1nc2cc(C(F)(F)F)ccc2s1 ; CC1(C)OB(Cc2nn(Cc3nc4cc(C(F)(F)F)ccc4s3)c(=O)c3nccnc23)OC1(C)C ; O=c1c2nccnc2c(CB(O)O)nn1Cc1nc2cc(Cl)ccc2s1 ; CC1(C)OB(Cc2nn(Cc3nc4cc(Cl)ccc4s3)c(=O)c3nccnc23)OC1(C)C ; O=c1c2nccnc2c(CB(O)O)nn1Cc1nc2cc(F)ccc2s1 ; CC1(C)OB(Cc2nn(Cc3nc4cc(F)ccc4s3)c(=O)c3nccnc23)OC1(C)C]

or pharmaceutically acceptable salts, pro-drugs or solvates thereof.

In one aspect, the disclosure relates to aldose reductase inhibitors of Formula (III),

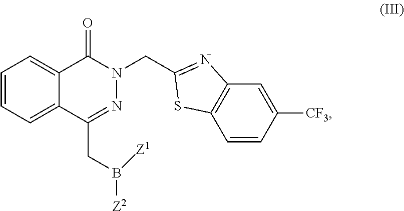

or pharmaceutically acceptable salts, pro-drugs or solvates thereof;
wherein,

Z¹ and Z² are independently selected from the group consisting of hydroxy, alkoxy, aryloxy, or Z¹ and Z² taken together with the boron atom to which they are bonded form

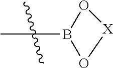

wherein,

X is a substituted or unsubstituted C₂-C₅ alkylene.

In an embodiment, the compounds of Formula (III) is

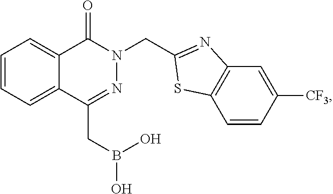 [SMILES: O=c1c2ccccc2c(CB(O)O)nn1Cc1nc2cc(C(F)(F)F)ccc2s1]

or pharmaceutically acceptable salts, pro-drugs or solvates thereof.

In an embodiment, the compounds of Formula (III) is

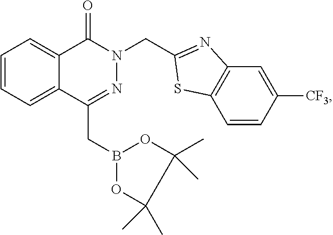 [SMILES: CC1(C)OB(Cc2nn(Cc3nc4cc(C(F)(F)F)ccc4s3)c(=O)c3ccccc23)OC1(C)C]

or pharmaceutically acceptable salts, pro-drugs or solvates thereof.

Synthesis

The compounds described herein relates to aldose reductase inhibitors of Formula (I), (II) and (III), and salts, pro-drugs or solvates thereof can be prepared according to known processes. Different methods will be evident to those skilled in the art. Various modifications to these methods may be envisioned by those skilled in the art to achieve similar results to that of the inventors provided below. For example, optional protecting groups can be used as described, for example, in Greene et al., Protective Groups in Organic Synthesis (4^{th} Ed. 2006).

Compounds of Formula (I) can be synthesized according to Schemes 1-19, for example, and by nickel-catalyzed decarboxylative borylation or other suitable methods (See, e.g., C. Li et al., Science 10.1126/science.aam7355 (2017). In the Schemes 1-19, R¹ is CO₂R² or CO₂⁻X⁺, R² is H, (C₁-C₆)-alkyl, (C₁-C₆)-hydroxyalkyl, or (C₁-C₆)-aminoalkyl and X⁺ is a counter ion; or a pharmaceutically acceptable salt or solvate thereof.

The compounds of Formula (I-1) can generally be prepared, for example, according to Scheme 1:

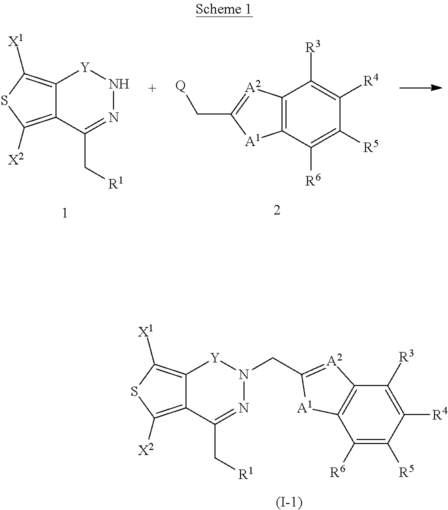

where X¹, X², R¹, A¹, A², R², R³ through R⁷ are defined as above and Q is a halogen, such as Cl, Br, I, and the like, or any other leaving group, such as OSO₂Me, OMs, OTs, OTf, and the like.

The compounds of Formula (I-2) can generally be prepared, for example, according to Scheme 2:

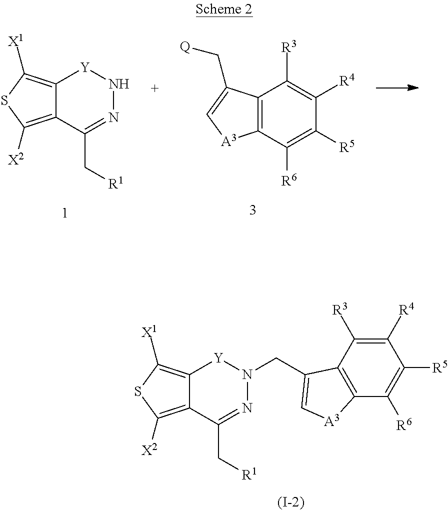

where X¹, X², R¹, A¹, A², R², R³ through R⁷ are defined as above and Q is a halogen, such as Cl, Br, I, and the like, or any other leaving group, such as OSO₂Me, OMs, OTs, OTf, and the like.

The compounds of Formula (I-3) can generally be prepared, for example, according to Scheme 3:

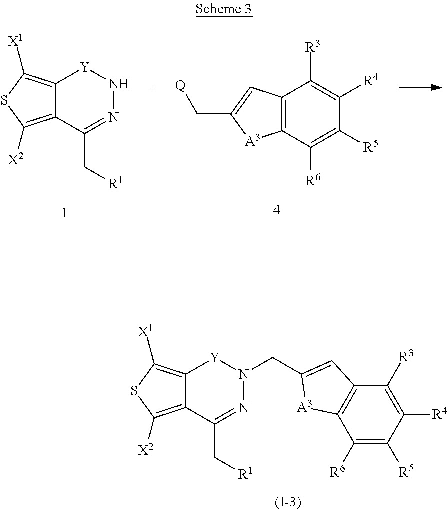

where X¹, X², R¹, A¹, A², R², R³ through R⁷ are defined as above and Q is a halogen, such as Cl, Br, I, and the like, or any other leaving group, such as OSO₂Me, OMs, OTs, OTf, and the like.

In certain embodiments, the reaction can be carried out in the presence of a base, such as potassium tert-butoxide, sodium hydride, sodium methoxide, sodium ethoxide, and the like.

In certain embodiments, the reaction can be carried out using aprotic solvents, such as DMF, THF, NMP, and the like. In certain embodiments, the reaction can be carried out using alcohol solvents, such as methanol, ethanol, and the like.

In certain embodiments, the reaction can be carried out at temperatures of between about 5° C. to about 80° C., such as 20° C. to 30° C.

In certain embodiments, the reaction can be subsequently followed by further separation and purification steps, such as chromatography (e.g., flash, HPLC, MPLC, etc.), crystallization, and the like.

The compounds of Formula (I-1) can also generally be prepared according to exemplary Scheme 4. Cyclic anhydride 5 is converted to compound 6 under acidic methanolysis conditions. Activation of the compound 6, followed by nucleophilic addition and decarboxylation provides ketoester 7. Treatment of compound 7 with hydrazine affords cyclized compound 8. Compound 8 is then coupled to compound 2 under basic conditions to provide a compound of formula 9. Deprotection or hydrolysis of compound 9 provides a compound of formula 10.

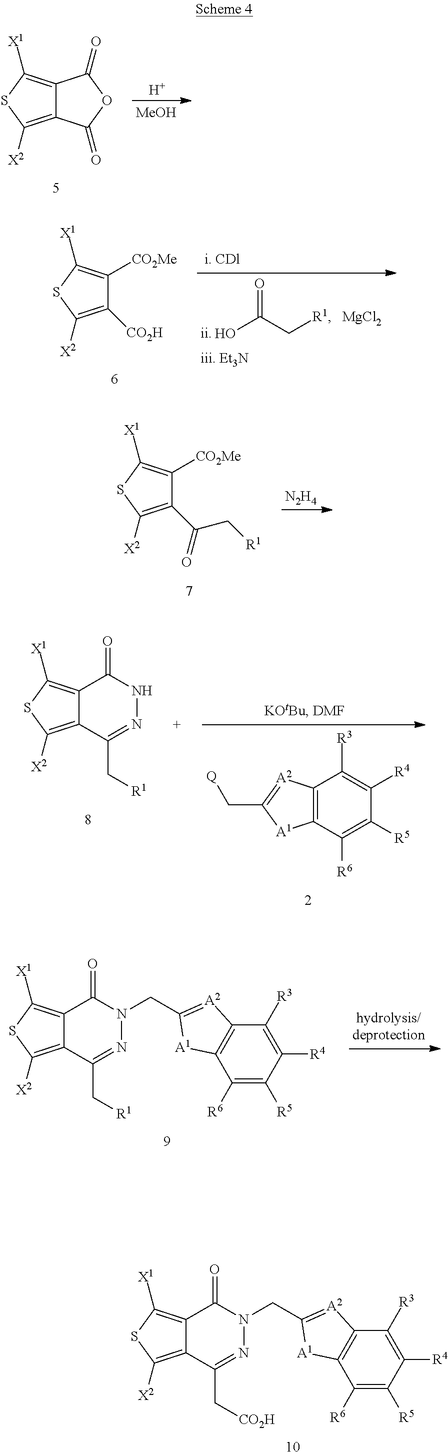

The compounds of Formula (I-2) can also generally be prepared according to Scheme 4, by replacing

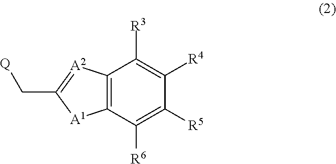

with

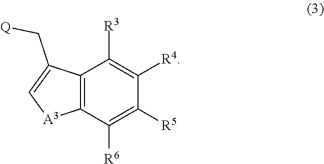

Similarly, the compounds of Formula (I-3) can also generally be prepared according to Scheme 4, by replacing

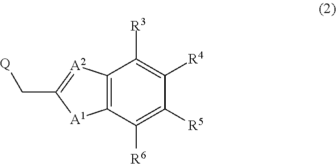

with

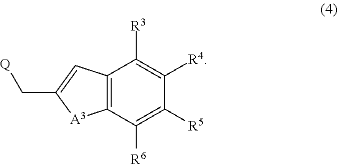

Other suitable reactions are possible, such as hydrolysis of the compound of Formula (I) in to obtain different forms of the compound of Formula (I-1), (I-2), or (I-3). For example, compounds having tert-butoxy, methoxy, ethoxy, and the like group as R² can be hydrolyzed by reacting with a suitable reagent, such as trifluoroacetic acid (TFA), HCl, KOH, or the like, to obtain a compound of Formula (I) having hydrogen as R².

For example, the following exemplary synthesis can be carried out according to Scheme 5.

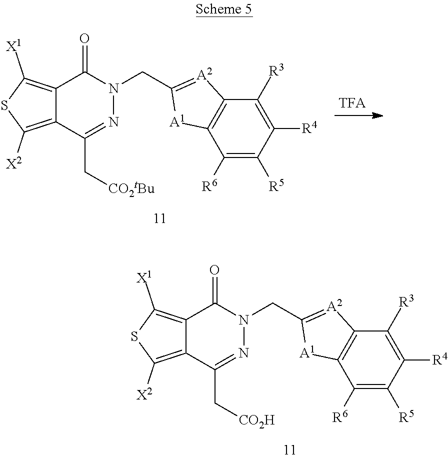

In some other embodiments, where Y is C═O, subsequent reactions can be carried out to replace C═O with C═S or C═N, or the like.

Compounds of Formula (2)

To obtain compounds of Formula (2), different possibilities exist. Compounds of Formula (2) can be synthesized by a variety of different reactions, such as a condensation reaction as schematically illustrated below in Scheme 6. The reaction can be carried out using a variety of solvents, such as ethanol, methanol, DMF, AcOH, and the like. The reaction can be carried out at temperatures of between about 5° C. to about 80° C., such as, for example, 55° C. to 65° C.

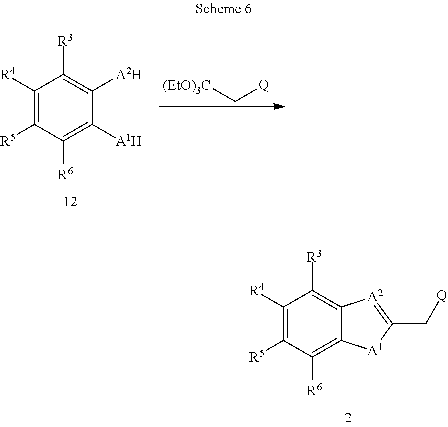

Additional exemplary descriptions regarding synthesis of certain compounds of Formula (2) are described in J. Med. Chem. (1991), Vol. 34, pp. 108-122; J. Med. Chem. (1992), Vol. 35, No. 3, pp. 457-465; and U.S. Pat. No. 8,916,563; each of which hereby incorporated by reference in its entirety.

Compounds of Formula (1)

To obtain compounds of Formula (1), different possibilities exist. For example, compounds of Formula (1) can be synthesized as shown in Scheme 7. For example, to obtain a compound of Formula (1) when Y is C═O, reaction of a compound represented by Formula (13) with a reagent that causes addition-cyclization reaction, such as hydrazine, can be carried out as shown in Scheme 7. The reaction can be carried out using a variety of solvents, such as ethanol, methanol, THF, and the like. The reaction can be carried out at temperatures of between about 20° C. to about 100° C., such as 60° C. to 80° C.

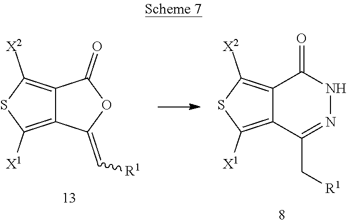

The compounds of Formula (13) can be obtained, for example, by a reaction of an anhydride with a reagent that causes a Wittig reaction, such as (tert-butoxycarbonylmethylene)-triphenylphosphorane, and the like, as shown in Scheme 8. The reaction can be carried out using aprotic solvents, such as CH₂Cl₂, THF, 1,4-dioxane, toluene, and the like. The reaction can be carried out at temperatures of between about 20° C. to about 110° C., such as 55° C. to 70° C.

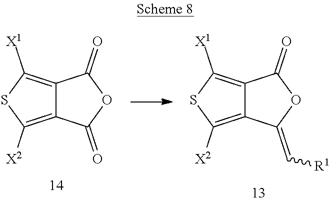

In certain embodiments, reaction of an anhydride, such as compound 15, with a reagent that causes a Wittig reaction can lead to a mixture of the particular compounds represented by 16 and 17, as exemplified below (Scheme 9). In such instances, if necessary, the mixture can be separated and purified to obtain the particular compounds of interest (e.g., compound 16 or 17).

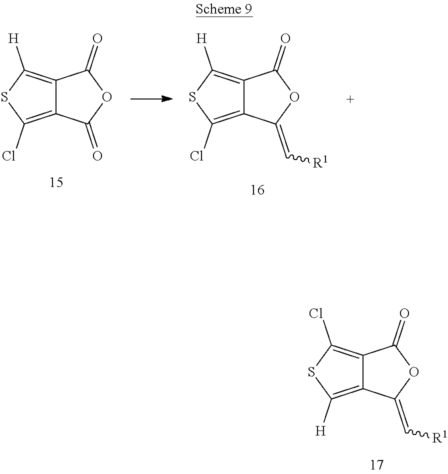

In certain embodiments, the compounds of Formula (13) can be obtained by the Perkins Reaction, as shown in Scheme 10. The Perkins reaction can employ KOAc/Ac₂O, as shown in Scheme 10. However, other temperatures and other bases, such as K₂CO₃ and the like can be utilized. Additional details of the Perkins reaction can be found in WO 03/061660, the contents of which are incorporated by reference herein in its entirety.

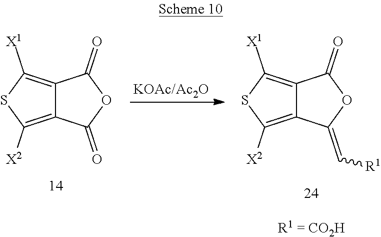

The compounds of Formula (14) can be obtained by reaction of dicarboxylic acid derivative represented by Formula (18) with a suitable anhydride forming reagent, such as dicyclohexylcarbodiimide (DCC) or acetic anhydride, to obtain the compounds of Formula (14) as schematically illustrated below (Scheme 11). The reaction can be carried out using non-nucleophilic solvents, such as acetic anhydride, THF, and the like. The reaction can be carried out at temperatures of between about 20° C. to about 100° C., such as 60° C. to 80° C.

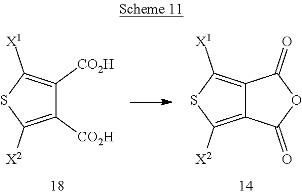

The compounds of Formula (14) can also be obtained as described by Ayres et al. in Tetrahedron, 1975, 31, 1755-1760 (hereby incorporated by reference in its entirety). The compounds of Formula (14) can be converted to compounds of formula (I) by known methods, e.g., as described previously in U.S. Pat. No. 8,916,563 (hereby incorporated by reference in its entirety).

The compounds of Formula (18) can generally be obtained through commercial sources, such as Sigma-Aldrich. Alternatively, compounds of Formula (18) can be obtained by reaction of a suitable precursor represented by Formula (19) or Formula (20) with a suitable dicarboxylic acid derivative forming reagent, such as NaMnO₄ and/or NaOH, to obtain the compounds of Formula (18) as schematically illustrated below (Schemes 12 and 13). The reaction can be carried out using aqueous solvents, such as water. The reaction can be carried out at temperatures of between about 50° C. to about 100° C., such as 85° C. to 95° C.

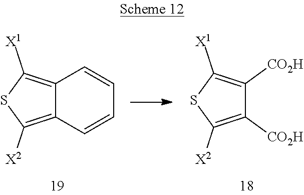

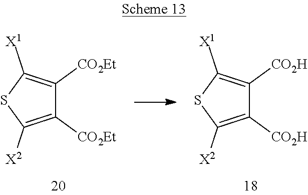

The compounds of Formula (18), where X¹ and X² are Cl, can be obtained as described by Ayres et al. in Tetrahedron, 1975, 31, 1755-1760 (hereby incorporated by reference in its entirety), as in shown in Scheme 14. Bis-iodination of compound 34 followed by transmetallation and carboxylation provides compound 36. Other halogenated derivatives can also be used as starting materials to provide compounds of Formula (18). Subsequent conversion of the di-carboxylic acid functional groups of compounds of Formula (18) to form a cyclic anhydride, as described above, provides compounds of Formula (14). Compounds of Formula (14) can be converted to compounds of formula (I) by known methods. Exemplary methods are described in U.S. Pat. No. 8,916,563 (hereby incorporated by reference in its entirety).

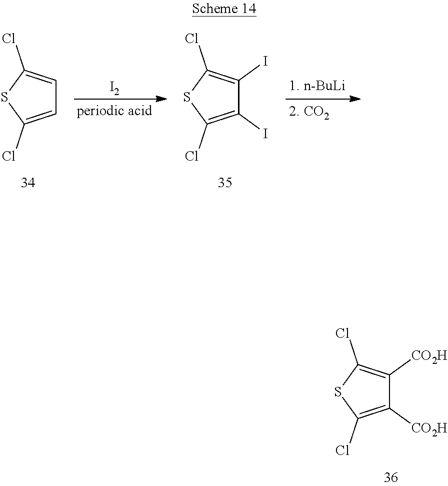

Additional Synthetic Schemes for Compound of Formula (I)

The synthetic schemes described above for preparing compounds of Formula (I) are illustrative and are not meant to limit the possible techniques one skilled in the art may use to prepare compounds disclosed herein. Different methods will be evident to those skilled in the art. Additional reactions can be carried out for the synthesis of additional embodiments of compounds represented by Formula (I).

To obtain compounds of Formula (I) where Y is C═S, the following synthesis can be carried out (Scheme 15). Treatment of compound 21 with Lawesson's reagent provides the corresponding thiocarbonyl derivative 22. Subsequent deprotection or hydrolysis provides compound 23.

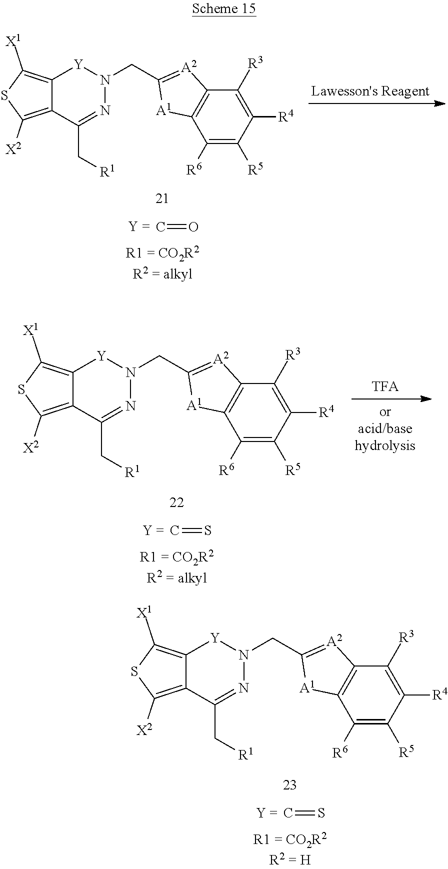

To obtain compounds of Formula (I) where Y is C═NR*, wherein R* represents hydrogen or an alkyl substituent for example, the following synthesis can be carried out (Scheme 16).

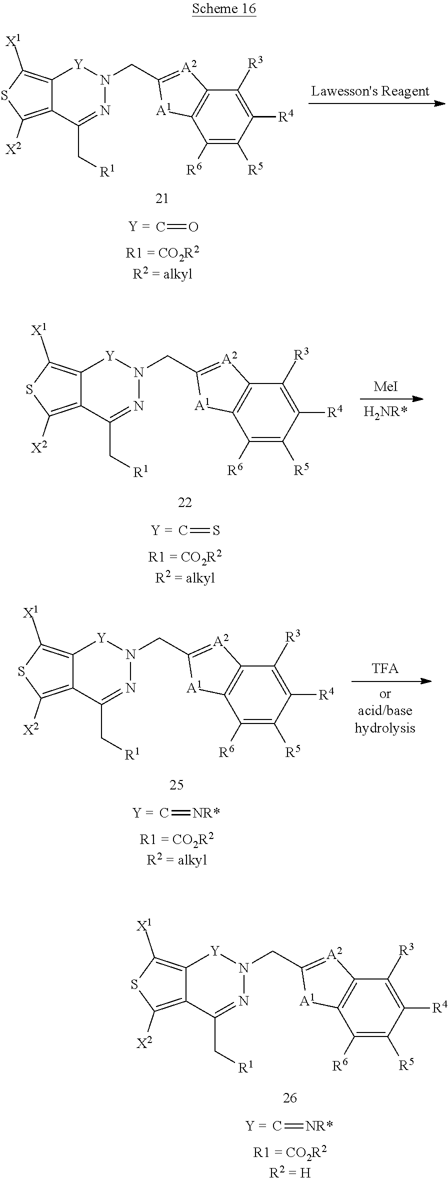

Compounds of Formula (I) where Y is a covalent bond can be prepared as described previously in U.S. Pat. No. 8,916,563.

Other substitutions and modifications are further possible as would be apparent to one of ordinary skill in the art. For example, in Scheme 17, KOH can be utilized in place of NaOH. In Scheme 18 below, KO^{t}Bu can be used in place of NaH. Additionally, instead of DMF, NMP or THF can be utilized.

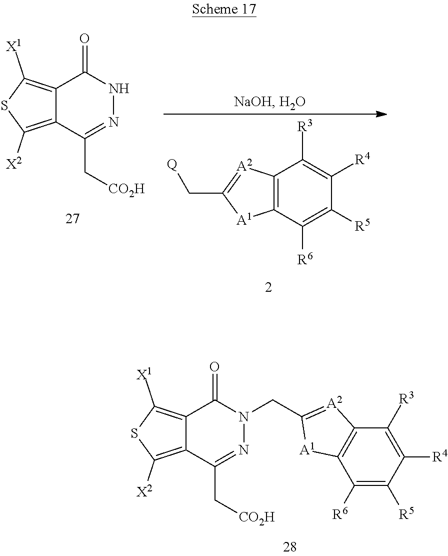

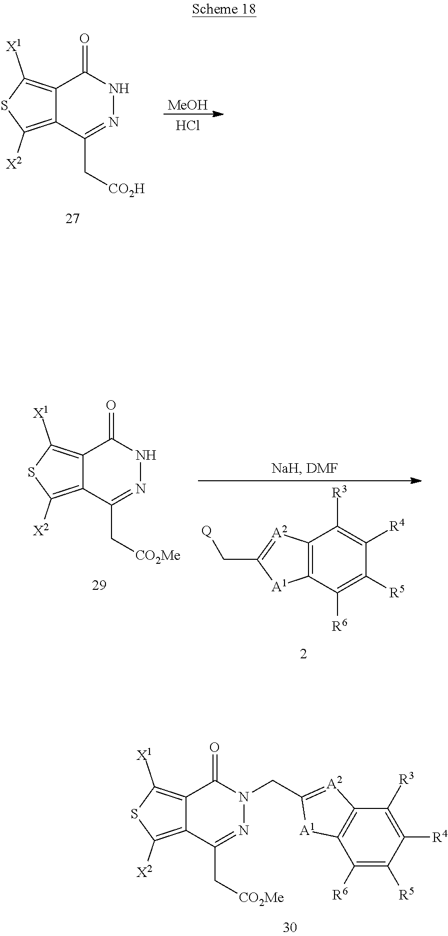

In certain embodiments, the following alternative synthesis can be carried out (Scheme 19).

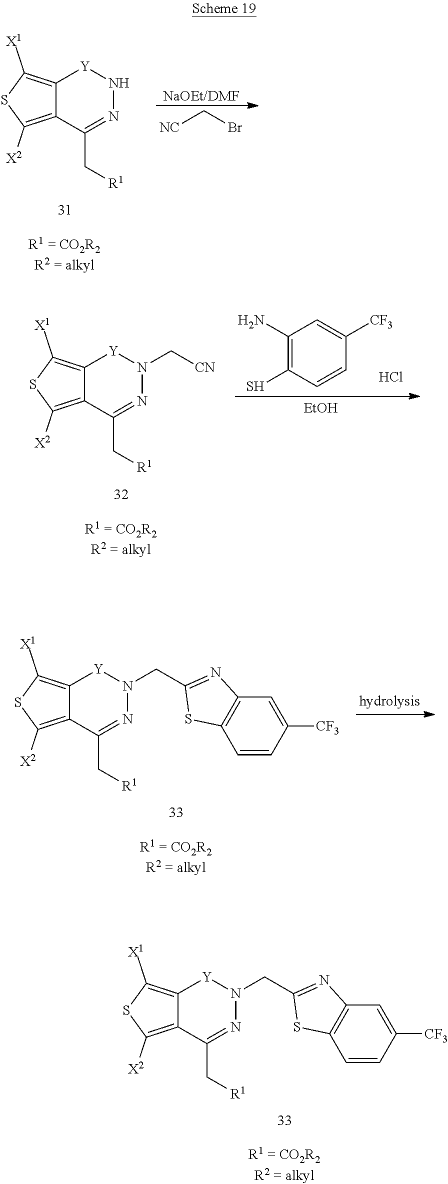

Compounds of Formula (II) can be synthesized, for example, using the method described in U.S. Pat. No. 8,916,653 and nickel-catalyzed decarboxylative borylation or other suitable methods.

Compounds of Formula (III) can be synthesized, for example, by nickel-catalyzed decarboxylative borylation of zopolrestat or other suitable methods. (See, e.g., C. Li et al., Science 10.1126/science.aam7355 (2017).)

Methods of Treatment

Compounds or compositions of the invention can be useful in applications that benefit from inhibition of aldose reductase enzymes. Exemplary utility of aldose reductase inhibition may be found, for example, in U.S. Pat. Nos. 8,916,563; 5,677,342; 5,155,259; 4,939,140; U.S. Publication Number US 2006/0293265A1; and Roy et al., in Diabetes Research and Clinical Practice, Vol. 10, Issue 1, 91-97; and references cited therein; each of which hereby incorporated by reference in its entirety. Inhibition of aldose reductase also has been found to prevent metastasis of colon cancer and mitosis in colon cancer cells (See, for example, Tammali, R. et al., Inhibition of Aldose Reductase Prevents Colon Cancer Metastasis, Carcinogenesis 2011, doi: 10.1093/carcin/bgr102; published online: Jun. 3, 2011; Angiogenesis 2011 May; 14(2):209-21; and Mol. Cancer Ther. 2010, April; 9(4): 813-824; each of which hereby incorporated by reference in its entirety).

In certain embodiments, compounds and/or compositions of the invention can be useful in promoting healthy aging of skin, the treatment of skin disorders, the treatment of angiogenesis disorders such as cancers, including colon cancer, the treatment of non-cardiac tissue damage, the treatment of cardiovascular disorders, the treatment of renal disorders, the treatment of evolving myocardial infarction, and the treatment various other disorders, such as complications arising from diabetes. Such disorders can include, but are not limited to, atherosclerosis, coronary artery disease, diabetic nephropathy, diabetic neuropathy, diabetic retinopathy, infections of the skin, peripheral vascular disease, stroke, and the like.

In certain embodiments, compounds and/or compositions of the invention can be useful in cardiovascular applications. For example, compounds and/or compositions of the invention can be used to treat subjects undergoing a heart bypass surgery to improve recovery after the surgery. In another example, compounds and/or compositions of the invention can be used to inhibit or reduce accumulation or rapid onset of atherosclerotic plaque.

In some other embodiments, compounds and/or compositions of the invention can be useful in topical applications. For example, compounds and/or compositions of the invention can be used to retard or reduce skin aging.

This disclosure relates to a method of treating a disease and/or condition caused by or related to aldose reductase, comprising administering to a subject in need thereof a therapeutically effective amount of an aldose reductase inhibitor of Formula (I), (II) or (III), including salts of such inhibitors. In some aspects the disease or condition that is treated is a cardiovascular disease or condition, such as cardiomyopathy, stroke, atherosclerosis, coronary artery disease, peripheral vascular disease, and myocardial infarction (MI) (e.g., acute MI, evolving MI). In other aspects the disease or condition that is treated is a complication of diabetes, such as diabetic cardiomyopathy, diabetic retinopathy, diabetic nephropathy and/or diabetic neuropathy. In other aspects, the disease or condition that is treated is retinopathy, nephropathy or neuropathy. In other aspects, the disease or condition that is treated is a metabolic disease in which aldose reductase is implicated in the pathological process. In a particular example, the disease to that is treated is galactosemia.

In certain embodiments, compounds of Formula (I), (II) and (III) can be administered to a subject in need of treatment at dosages ranging from about 0.5 to about 25 mg/kg body weight of the subject to be treated per day, such as from about 1.0 to 10 mg/kg. However, additional variations are within the scope of the invention.

The compound of Formula (I), (II) and (III) can be administered alone or in combination with pharmaceutically acceptable carriers, such as diluents, fillers, aqueous solution, and even organic solvents. The compound and/or compositions of the invention can be administered as a tablet, powder, lozenge, syrup, injectable solution, and the like. Additional ingredients, such as flavoring, binder, excipients, and the like are within the scope of the invention.

In certain embodiments, pharmaceutically acceptable compositions can contain a compound of Formula (I), (II) and (III) and/or a pharmaceutically acceptable salt thereof at a concentration ranging from about 0.01 to about 2 wt %, such as 0.01 to about 1 wt % or about 0.05 to about 0.5 wt %. The composition can be formulated as a solution, suspension, ointment, or a capsule, and the like. The pharmaceutical composition can be prepared as an aqueous solution and can contain additional components, such as preservatives, buffers, tonicity agents, antioxidants, stabilizers, viscosity-modifying ingredients and the like.

Other modes of administration can be found in U.S. Pat. No. 4,939,140, hereby incorporated by reference herein in its entirety.

In one embodiment, the present invention provides for the use of pharmaceutical compositions and/or medicaments comprised of a compound of Formula (I), (II) and (III), or a pharmaceutically acceptable salt, hydrate, solvate, or pro-drug thereof, in a method of treating a disease state, and/or condition caused by or related to aldose reductase.

In another embodiment, the method of treatment comprises the steps of: i) identifying a subject in need of such treatment; (ii) providing a compound of Formula (I), (II) and (III), or a pharmaceutically acceptable salt, hydrate, solvate, pro-drug or tautomer thereof; and (iii) administering said compound of Formula (I), (II) and (III) in a therapeutically effective amount to treat, suppress and/or prevent the disease state or condition in a subject in need of such treatment.

In another embodiment, the method of treatment comprises the steps of: i) identifying a subject in need of such treatment; (ii) providing a composition comprising a compound of Formula (I), (II) and (III), or a pharmaceutically acceptable salt, hydrate, solvate, pro-drug or tautomer thereof; and (iii) administering said composition in a therapeutically effective amount to treat, suppress and/or prevent the disease state or condition in a subject in need of such treatment.

In one embodiment, the subject in need is chimpanzees, apes monkeys, cattle, horses, sheep, goats, swine, rabbits, dogs, cats, rats, mice, guinea pigs, and the like. In some embodiments, the subject in need is a human.

In one embodiment, the compound or composition is administered orally. In another embodiment, the compound or composition is administered intravenously.

In one embodiment, the methods comprise administering to the subject a therapeutically effective amount of a compound of Formula (I), (II) and (III), or a pharmaceutically acceptable salt, solvate, hydrate or pro-drug thereof; or a composition comprising a compound of Formula (I), (II) and (III), or a pharmaceutically acceptable salt, solvate, hydrate or pro-drug thereof, and a pharmaceutically acceptable carrier.

Pharmaceutically acceptable carriers are well-known to those skilled in the art, and include, for example, adjuvants, diluents, excipients, fillers, lubricants and vehicles. In some embodiments, the carrier is a diluent, adjuvant, excipient, or vehicle. In some embodiments, the carrier is a diluent, adjuvant, or excipient. In some embodiments, the carrier is a diluent or adjuvant. In some embodiments, the carrier is an excipient. Often, the pharmaceutically acceptable carrier is chemically inert toward the active compounds and is non-toxic under the conditions of use. Examples of pharmaceutically acceptable carriers may include, for example, water or saline solution, polymers such as polyethylene glycol, carbohydrates and derivatives thereof, oils, fatty acids, or alcohols. Non-limiting examples of oils as pharmaceutical carriers include oils of petroleum, animal, vegetable or synthetic origin, such as peanut oil, soybean oil, mineral oil, sesame oil and the like. The pharmaceutical carriers may also be saline, gum acacia, gelatin, starch paste, talc, keratin, colloidal silica, urea, and the like. In addition, auxiliary, stabilizing, thickening, lubricating and coloring agents may be used. Other examples of suitable pharmaceutical carriers are described in e.g., Remington's: The Science and Practice of Pharmacy, 22^{nd} Ed. (Allen, Loyd V., Jr ed., Pharmaceutical Press (2012)); Modem Pharmaceutics, 5^{th} Ed. (Alexander T. Florence, Juergen Siepmann, CRC Press (2009)); Handbook of Pharmaceutical Excipients, 7^{th} Ed. (Rowe, Raymond C.; Sheskey, Paul J.; Cook, Walter G.; Fenton, Marian E. eds., Pharmaceutical Press (2012)) (each of which hereby incorporated by reference in its entirety).

In one embodiment, a pharmaceutical composition is a mixture of one or more of the compounds described herein, or pharmaceutically acceptable salts, pro-drugs, or solvates thereof, with other chemical components, such as physiologically acceptable carriers and excipients. The purpose of a pharmaceutical composition is to facilitate administration of a compound to an organism or subject.

In another embodiment, the method of treatment, prevention and/or suppression of a condition related to aldose reductase comprises the steps of: i) identifying a subject in need of such treatment; (ii) providing a compound of Formula (I), (II) and (III), or a pharmaceutically acceptable salt, solvate, hydrate or pro-drug thereof; or a composition comprising a compound of Formula (I), (II) and (III), or a pharmaceutically acceptable salt, solvate, hydrate or pro-drug thereof, and a pharmaceutically acceptable carrier; and (iii) administering said compound or composition in a therapeutically effective amount to treat, prevent and/or suppress the disease state or condition related to aldose reductase in a subject in need of such treatment.

In one embodiment, the present invention also encompasses methods comprising pro-drugs of compounds of Formula (I), (II) and (III) and/or pharmaceutical compositions thereof. Pro-drugs include derivatives of compounds that can hydrolyze, oxidize, or otherwise react under biological conditions (in vitro or in vivo) to provide an active compound of the invention. Examples of pro-drugs include, but are not limited to, derivatives and metabolites of a compound of the invention that include biohydrolyzable moieties such as biohydrolyzable amides, biohydrolyzable esters, biohydrolyzable carbamates, biohydrolyzable carbonates, and biohydrolyzable phosphate analogues. Pro-drugs may be comprised of structures wherein an acid group is masked, for example, as an ester or amide. Pro-drugs are also described in, for example, by Alexander et al., J. Med Chem. 1988, 31, 318; and in The Practice of Medicinal Chemistry (Camille Wermuth, ed., 1999, Academic Press; hereby incorporated by reference in its entirety). Pro-drugs are often useful because, in some situations, they are easier to administer than the parent drug. They are bioavailable, for instance, by oral administration whereas the parent drug is either less bioavailable or not bioavailable. In some embodiments, the pro-drug has improved solubility in pharmaceutical compositions over the parent drug. For example, the compound carries protective groups that are removed in vivo, thus releasing active compound.

In certain embodiments, pro-drugs of compounds with carboxyl functional groups are the (C₁-C₄) alkyl esters of the carboxylic acid. The carboxylate esters are conveniently formed by esterifying any of the carboxylic acid moieties present on the molecule. Pro-drugs can typically be prepared using well-known methods, such as those described by Burger's Medicinal Chemistry and Drug Discovery 6^{th} Ed. (Donald J. Abraham ed., 2001, Wiley) and Design and Application of Pro-drugs (H. Bundgaard ed., 1985, Harwood Academic Publishers Gmfh; each of which hereby incorporated by reference in its entirety). Biohydrolyzable moieties of a compound of Formula (I) (i) do not interfere with the biological activity of the compound but can confer upon that compound advantageous properties in vivo, such as uptake, duration of action, or onset of action; or (ii) may be biologically inactive but are converted in vivo to the biologically active compound. Examples of biohydrolyzable esters include, but are not limited to, (C₁-C₄) alkyl esters, alkoxyacyloxy esters, alkyl acylamino alkyl esters, and choline esters. Examples of biohydrolyzable amides include, but are not limited to, (C₁-C₄) alkyl amides, α-amino acid amides, alkoxyacyl amides, and alkylaminoalkylcarbonyl amides. Examples of biohydrolyzable carbamates include, but are not limited to, (C₁-C₄) alkylamines, substituted ethylenediamines, aminoacids, hydroxyalkylamines, heterocyclic and heteroaromatic amines, and polyether amines. In some embodiments, the biohydrolyzable moiety is a (C₁-C₄) alkyl ester, an alkoxyacyloxy ester, an alkyl acylamino alkyl ester, or a choline ester. In some embodiments, the biohydrolyzable moiety is a (C₁-C₄) alkyl ester, an alkoxyacyloxy ester, or an alkyl acylamino alkyl ester. In some embodiments, the biohydrolyzable moiety is a (C₁-C₄) alkyl ester or an alkoxyacyloxy ester. In some embodiments, the biohydrolyzable moiety is a (C₁-C₄) alkyl ester. In some embodiments, the biohydrolyzable moiety is a (C₁-C₃) alkyl ester. In some embodiments, the biohydrolyzable moiety is a methyl ester or an ethyl ester. In some embodiments, the biohydrolyzable moiety is a t-butyl ester. In some embodiments, the biohydrolyzable moiety is a (C₁-C₄) alkyl amide, an α-amino acid amide, an alkoxyacyl amide, or an alkylaminoalkylcarbonyl amide. In some embodiments, the biohydrolyzable moiety is a (C₁-C₄) alkyl amide, an α-amino acid amide, or an alkoxyacyl amide. In some embodiments, the biohydrolyzable moiety is a (C₁-C₄) alkyl amide or an α-amino acid amide. In some embodiments, the biohydrolyzable moiety is a (C₁-C₄) alkyl amide.

In some embodiments, the biohydrolyzable moiety is a (C₁-C₄) alkyl amine, a substituted ethylenediamine, an aminoacid, a hydroxyalkylamine, a heterocyclic amine, a heteroaromatic amine, or a polyether amine. In some embodiments, the biohydrolyzable moiety is a (C₁-C₄) alkyl amine, an aminoacid, a hydroxyalkylamine, a heterocyclic amine, a heteroaromatic amine, or a polyether amine. In some embodiments, the biohydrolyzable moiety is a (C₁-C₄) alkyl amine, an aminoacid, a hydroxyalkylamine, or a polyether amine. In some embodiments, the biohydrolyzable moiety is a (C₁-C₄) alkyl amine, an aminoacid, or a hydroxyalkylamine. In some embodiments, the biohydrolyzable moiety is a (C₁-C₄) alkyl amine.

In one embodiment, the compounds of the invention are formulated into pharmaceutical compositions for administration to subjects in a biologically compatible form suitable for administration in vivo. According to another aspect, the present invention provides a pharmaceutical composition comprising a compound of Formula (I), (II) and (III) in admixture with a pharmaceutically acceptable diluent and/or carrier. The pharmaceutically-acceptable carrier is “acceptable” in the sense of being compatible with the other ingredients of the composition and not deleterious to the recipient thereof. The pharmaceutically-acceptable carriers employed herein may be selected from various organic or inorganic materials that are used as materials for pharmaceutical formulations and which are incorporated as analgesic agents, buffers, binders, disintegrants, diluents, emulsifiers, excipients, extenders, glidants, solubilizers, stabilizers, suspending agents, tonicity agents, vehicles and viscosity-increasing agents. Pharmaceutical additives, such as antioxidants, aromatics, colorants, flavor-improving agents, preservatives, and sweeteners, may also be added. Examples of acceptable pharmaceutical carriers include carboxymethyl cellulose, crystalline cellulose, glycerin, gum arabic, lactose, magnesium stearate, methyl cellulose, powders, saline, sodium alginate, sucrose, starch, talc and water, among others. In one embodiment, the term “pharmaceutically acceptable” means approved by a regulatory agency of the Federal or a state government or listed in the U.S. Pharmacopeia or other generally recognized pharmacopeia for use in animals, and more particularly in humans.

Surfactants such as, for example, detergents, are also suitable for use in the formulations. Specific examples of surfactants include polyvinylpyrrolidone, polyvinyl alcohols, copolymers of vinyl acetate and of vinylpyrrolidone, polyethylene glycols, benzyl alcohol, mannitol, glycerol, sorbitol or polyoxyethylenated esters of sorbitan; lecithin or sodium carboxymethylcellulose; or acrylic derivatives, such as methacrylates and others, anionic surfactants, such as alkaline stearates, in particular sodium, potassium or ammonium stearate; calcium stearate or triethanolamine stearate; alkyl sulfates, in particular sodium lauryl sulfate and sodium cetyl sulfate; sodium dodecylbenzenesulphonate or sodium dioctyl sulphosuccinate; or fatty acids, in particular those derived from coconut oil, cationic surfactants, such as water-soluble quaternary ammonium salts of formula N⁺R′R″R′″R″″Y⁻, in which the R radicals are identical or different optionally hydroxylated hydrocarbon radicals and Y⁻ is an anion of a strong acid, such as halide, sulfate and sulfonate anions; cetyltrimethylammonium bromide is one of the cationic surfactants which can be used, amine salts of formula N⁺R′R″R′″, in which the R radicals are identical or different optionally hydroxylated hydrocarbon radicals; octadecylamine hydrochloride is one of the cationic surfactants which can be used, non-ionic surfactants, such as optionally polyoxyethylenated esters of sorbitan, in particular Polysorbate 80, or polyoxyethylenated alkyl ethers; polyethylene glycol stearate, polyoxyethylenated derivatives of castor oil, polyglycerol esters, polyoxyethylenated fatty alcohols, polyoxyethylenated fatty acids or copolymers of ethylene oxide and of propylene oxide, amphoteric surfactants, such as substituted lauryl compounds of betaine,

When administered to a subject, the compound of Formula (I), (II) and (III) and pharmaceutically acceptable carriers can be sterile. Suitable pharmaceutical carriers may also include excipients such as starch, glucose, lactose, sucrose, gelatin, malt, rice, flour, chalk, silica gel, sodium stearate, glycerol monostearate, talc, sodium chloride, dried skim milk, glycerol, propylene, glycol, polyethylene glycol 300, water, ethanol, polysorbate 20, and the like. The present compositions, if desired, may also contain minor amounts of wetting or emulsifying agents, or pH buffering agents.

The pharmaceutical formulations of the present invention are prepared by methods well-known in the pharmaceutical arts. Optionally, one or more accessory ingredients (e.g., buffers, flavoring agents, surface active agents, and the like) also are added. The choice of carrier is determined by the solubility and chemical nature of the compounds, chosen route of administration and standard pharmaceutical practice.

Additionally, the compounds and/or compositions of the present invention are administered to a subject by known procedures including oral administration, sublingual or buccal administration. In one embodiment, the compound and/or composition is administered orally.

For oral administration, a formulation of the compounds of the invention may be presented in dosage forms such as capsules, tablets, powders, granules, or as a suspension or solution. Capsule formulations may be gelatin, soft-gel or solid. Tablets and capsule formulations may further contain one or more adjuvants, binders, diluents, disintegrants, excipients, fillers, or lubricants, each of which are known in the art. Examples of such include carbohydrates such as lactose or sucrose, dibasic calcium phosphate anhydrous, corn starch, mannitol, xylitol, cellulose or derivatives thereof, microcrystalline cellulose, gelatin, stearates, silicon dioxide, talc, sodium starch glycolate, acacia, flavoring agents, preservatives, buffering agents, disintegrants, and colorants. Orally administered compositions may contain one or more optional agents such as, for example, sweetening agents such as fructose, aspartame or saccharin; flavoring agents such as peppermint, oil of wintergreen, or cherry; coloring agents; and preservative agents, to provide a pharmaceutically palatable preparation.

In some embodiments, the composition is in unit dose form such as a tablet, capsule or single-dose vial. Suitable unit doses, i.e., therapeutically effective amounts, may be determined during clinical trials designed appropriately for each of the conditions for which administration of a chosen compound is indicated and will, of course, vary depending on the desired clinical endpoint.

In accordance with the methods of the present invention, the compounds of the invention are administered to the subject in a therapeutically effective amount, for example to reduce or ameliorate symptoms related to aldose reductase activity in the subject. This amount is readily determined by the skilled artisan, based upon known procedures, including analysis of titration curves established in vivo and methods and assays disclosed herein.

In one embodiment, the methods comprise administration of a therapeutically effective dosage of the compounds of the invention. In some embodiments, the therapeutically effective dosage is at least about 0.05 mg/kg body weight, at least about 0.1 mg/kg body weight, at least about 0.25 mg/kg body weight, at least about 0.3 mg/kg body weight, at least about 0.5 mg/kg body weight, at least about 0.75 mg/kg body weight, at least about 1 mg/kg body weight, at least about 2 mg/kg body weight, at least about 3 mg/kg body weight, at least about 4 mg/kg body weight, at least about 5 mg/kg body weight, at least about 6 mg/kg body weight, at least about 7 mg/kg body weight, at least about 8 mg/kg body weight, at least about 9 mg/kg body weight, at least about 10 mg/kg body weight, at least about 15 mg/kg body weight, at least about 20 mg/kg body weight, at least about 25 mg/kg body weight, at least about 30 mg/kg body weight, at least about 40 mg/kg body weight, at least about 50 mg/kg body weight, at least about 75 mg/kg body weight, at least about 100 mg/kg body weight, at least about 200 mg/kg body weight, at least about 250 mg/kg body weight, at least about 300 mg/kg body weight, at least about 350 mg/kg body weight, at least about 400 mg/kg body weight, at least about 450 mg/kg body weight, at least about 500 mg/kg body weight, at least about 550 mg/kg body weight, at least about 600 mg/kg body weight, at least about 650 mg/kg body weight, at least about 700 mg/kg body weight, at least about 750 mg/kg body weight, at least about 800 mg/kg body weight, at least about 900 mg/kg body weight, or at least about 1000 mg/kg body weight. It will be recognized that any of the dosages listed herein may constitute an upper or lower dosage range, and may be combined with any other dosage to constitute a dosage range comprising an upper and lower limit.

In some embodiments, the methods comprise a single dosage or administration (e.g., as a single injection or deposition). Alternatively, the methods comprise administration once daily, twice daily, three times daily or four times daily to a subject in need thereof for a period of from about 2 to about 28 days, or from about 7 to about 10 days, or from about 7 to about 15 days, or longer. In some embodiments, the methods comprise chronic administration. In yet other embodiments, the methods comprise administration over the course of several weeks, months, years or decades. In still other embodiments, the methods comprise administration over the course of several weeks. In still other embodiments, the methods comprise administration over the course of several months. In still other embodiments, the methods comprise administration over the course of several years. In still other embodiments, the methods comprise administration over the course of several decades.

The dosage administered can vary depending upon known factors such as the pharmacodynamic characteristics of the active ingredient and its mode and route of administration; time of administration of active ingredient; age, sex, health and weight of the recipient; nature and extent of symptoms; kind of concurrent treatment, frequency of treatment and the effect desired; and rate of excretion. These are all readily determined and may be used by the skilled artisan to adjust or titrate dosages and/or dosing regimens.

The precise dose to be employed in the compositions will also depend on the route of administration, and should be decided according to the judgment of the practitioner and each subject's circumstances. In specific embodiments of the invention, suitable dose ranges for oral administration of the compounds of the invention are generally about 1 mg/day to about 1000 mg/day. In one embodiment, the oral dose is about 1 mg/day to about 800 mg/day. In one embodiment, the oral dose is about 1 mg/day to about 500 mg/day. In another embodiment, the oral dose is about 1 mg/day to about 250 mg/day. In another embodiment, the oral dose is about 1 mg/day to about 100 mg/day. In another embodiment, the oral dose is about 5 mg/day to about 50 mg/day. In another embodiment, the oral dose is about 5 mg/day. In another embodiment, the oral dose is about 10 mg/day. In another embodiment, the oral dose is about 20 mg/day. In another embodiment, the oral dose is about 30 mg/day. In another embodiment, the oral dose is about 40 mg/day. In another embodiment, the oral dose is about 50 mg/day. In another embodiment, the oral dose is about 60 mg/day. In another embodiment, the oral dose is about 70 mg/day. In another embodiment, the oral dose is about 100 mg/day. It will be recognized that any of the dosages listed herein may constitute an upper or lower dosage range, and may be combined with any other dosage to constitute a dosage range comprising an upper and lower limit.

Any of the compounds and/or compositions of the invention may be provided in a kit comprising the compounds and/or compositions. Thus, in one embodiment, the compound and/or composition of the invention is provided in a kit.

Those skilled in the art will recognize, or be able to ascertain using no more than routine experimentation, many equivalents to the specific embodiments of the invention described herein. Such equivalents are intended to be within the scope of the present invention.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways within the scope and spirit of the invention.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

1. A compound of Formula (I) 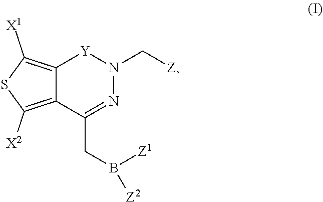
or pharmaceutically acceptable salts, pro-drugs or solvates thereof;
wherein,
X¹ is H or halogen;
X² is H or halogen;
Y is a bond, C═O, C═S, C═NH, or C═N(C₁-C₄)-alkyl;
Z¹ and Z² are independently selected from the group consisting of hydroxy, alkoxy, aryloxy, or Z¹ and Z² taken together with the boron atom to which they are bonded form 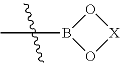
wherein,
X is a substituted or unsubstituted C₂-C₅ alkylene;
Z is 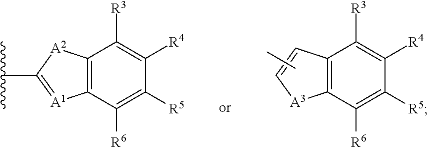
A¹ is NR⁷, O, S or CH₂;
A² is N or CH;
A³ is NR⁷, O, or S;
R³ through R⁶ are independently hydrogen, halogen, cyano, acyl, haloalkyl, haloalkoxy, haloalkylthio, trifluoroacetyl, (C₁-C₄)-alkyl, (C₁-C₄)-alkoxy, (C₁-C₄)-alkylthio, (C₁-C₄)-alkylsulfinyl, or (C₁-C₄)-alkylsulfonyl; and
R⁷ is hydrogen, C₁-C₄ alkyl, or C(O)O—(C₁-C₄)-alkyl.

2. The compound of claim 1 is 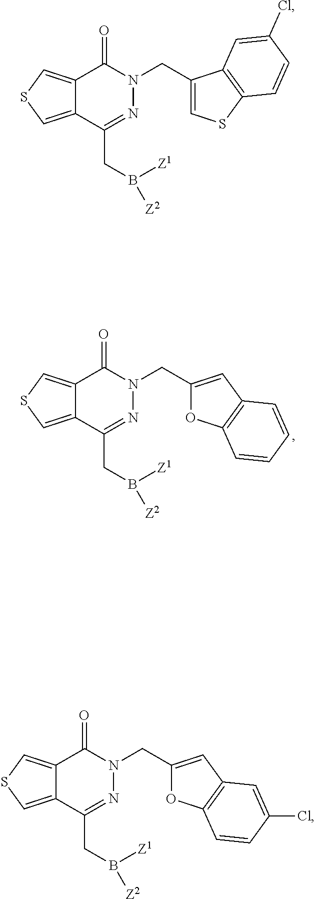
or pharmaceutically acceptable salts, pro-drugs or solvates thereof;
wherein,
Z¹ and Z² are independently selected from the group consisting of hydroxy, alkoxy, aryloxy, or Z¹ and Z² taken together with the boron atom to which they are bonded form 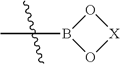
wherein,
X is a substituted or unsubstituted C₂-C₅ alkylene.

3. The compound of claim 1 is 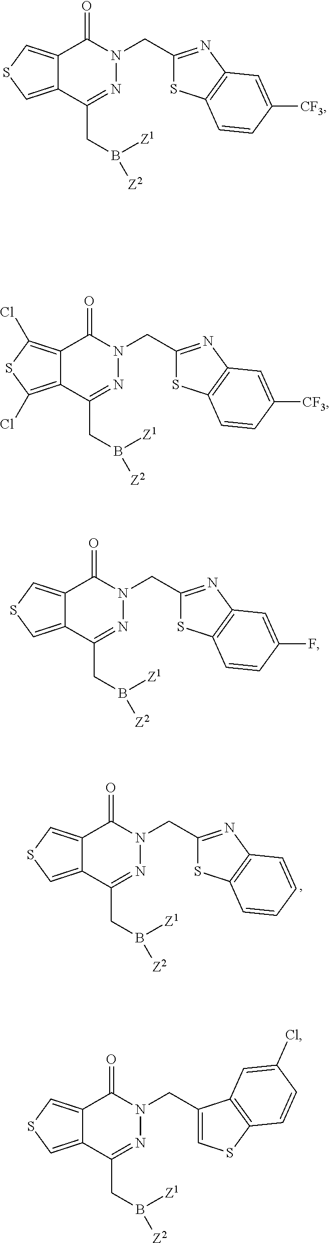 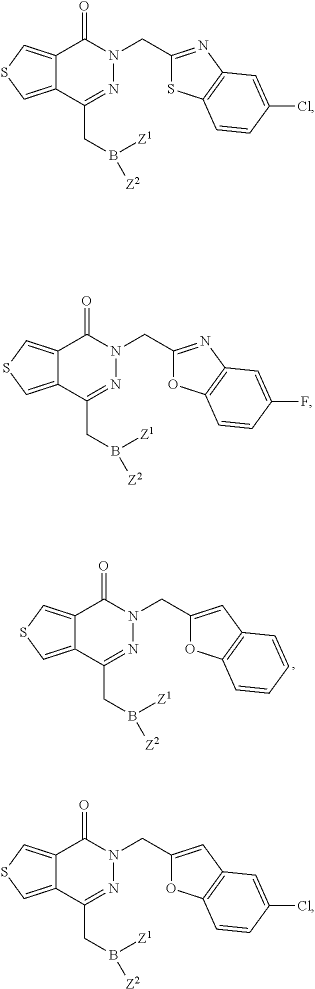
or pharmaceutically acceptable salts, pro-drugs or solvates thereof;
wherein,
Z¹ and Z² are independently selected from the group consisting of hydroxy, alkoxy, aryloxy, or Z¹ and Z² taken together with the boron atom to which they are bonded form 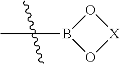
wherein,
X is a substituted or unsubstituted C₂-C₅ alkylene.

4. A compound of Formula (II) 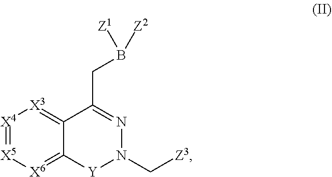
or pharmaceutically acceptable salts, pro-drugs or solvates thereof;
wherein,
X³ is N or CR⁸;
X⁴ is N or CR⁹;
X⁵ is N or CR¹⁰;
X⁶ is N or CR¹¹; with the proviso that two or three of X³, X⁴, X⁵, or X⁶ are N;
Y is a bond, C═O, C═S, C═NH, or C═N(C₁-C₄)-alkyl;
Z¹ and Z² are independently selected from the group consisting of hydroxy, alkoxy, aryloxy, or Z¹ and Z² taken together with the boron atom to which they are bonded form 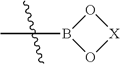
wherein,
X is a substituted or unsubstituted C₂-C₅ alkylene;
Z³ is 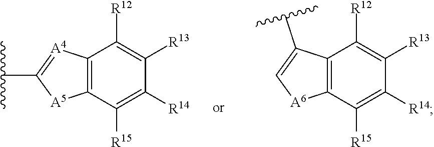
A⁴ is NR⁶, O, S or CH₂;
A⁵ is N or CH;
A⁶ is NR⁶, O, or S;
R⁸ through R¹⁵ are independently hydrogen, halogen, cyano, acyl, haloalkyl, haloalkoxy, haloalkylthio, trifluoroacetyl, (C₁-C₄)-alkyl, (C₁-C₄)-alkoxy, (C₁-C₄)-alkylthio, (C₁-C₄)-alkylsulfinyl, or (C₁-C₄)-alkylsulfonyl; or two of R⁸ through R¹¹ or two of R¹² through R¹⁵ taken together are (C₁-C₄)-alkylenedioxy; and
R¹⁶ is hydrogen, C₁-C₄ alkyl, or C(O)O—(C₁-C₄)-alkyl.

5. The compound of claim 4 is 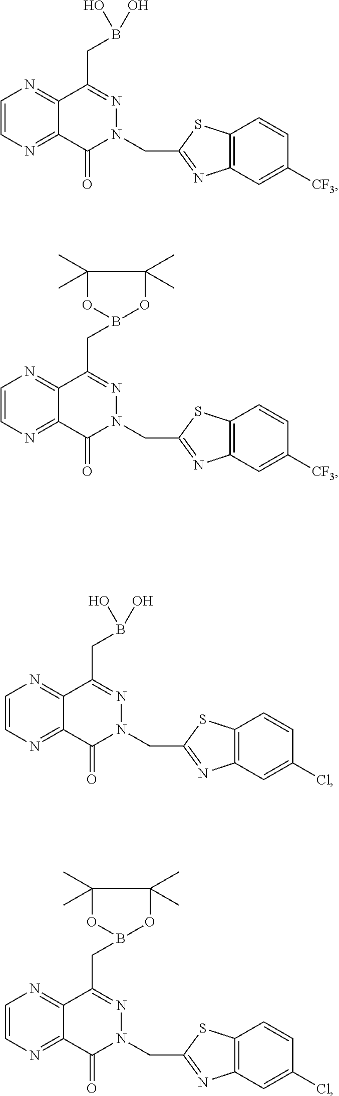 [SMILES: O=c1c2nccnc2c(CB(O)O)nn1Cc1nc2cc(C(F)(F)F)ccc2s1 ; CC1(C)OB(Cc2nn(Cc3nc4cc(C(F)(F)F)ccc4s3)c(=O)c3nccnc23)OC1(C)C ; O=c1c2nccnc2c(CB(O)O)nn1Cc1nc2cc(Cl)ccc2s1 ; CC1(C)OB(Cc2nn(Cc3nc4cc(Cl)ccc4s3)c(=O)c3nccnc23)OC1(C)C]
or pharmaceutically acceptable salts, pro-drugs or solvates thereof.

6. A compound of Formula (III) 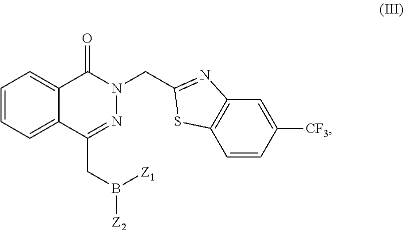
or pharmaceutically acceptable salts, pro-drugs or solvates thereof;
wherein,
Z¹ and Z² are independently selected from the group consisting of hydroxy, alkoxy, aryloxy, or Z¹ and Z² taken together with the boron atom to which they are bonded form 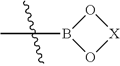
wherein,
X is a substituted or unsubstituted C₂-C₅ alkylene.

7. The compound of claim 6 is 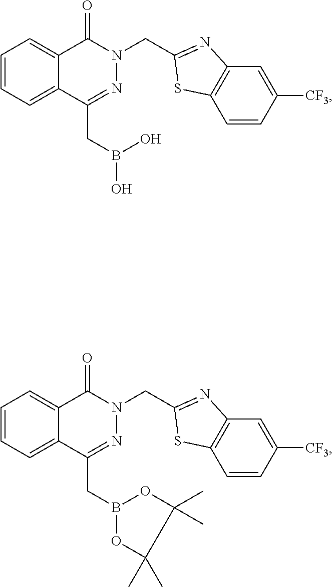 [SMILES: O=c1c2ccccc2c(CB(O)O)nn1Cc1nc2cc(C(F)(F)F)ccc2s1 ; CC1(C)OB(Cc2nn(Cc3nc4cc(C(F)(F)F)ccc4s3)c(=O)c3ccccc23)OC1(C)C]
or pharmaceutically acceptable salts, pro-drugs or solvates thereof.

8. A pharmaceutical composition comprising a compound of claim 1 and a pharmaceutically acceptable carrier.

9. A method of inhibiting aldose reductase activity in a subject comprising administration of a therapeutically effective amount of the compound of claim 1 to a subject in need thereof.

10. The method of claim 9, wherein the subject is diabetic.

11. The method of claim 9, wherein the subject is a human.

12. A method of treating a disorder in a subject comprising administration of a therapeutically effective amount of the compound of claim 1 to a subject in need thereof.

13. The method of claim 12, wherein the disorder is atherosclerosis.

14. The method of claim 12, wherein the disorder is selected from diabetic nephropathy, diabetic neuropathy, diabetic retinopathy, diabetic cardiomyopathy and cardiovascular disease.

15-18. (canceled)

19. The method of claim 12, wherein the disorder is peripheral vascular disease.

20. The method of claim 12, wherein the disorder is an angiogenesis disorder.

21. The method of claim 12, wherein the disorder is tissue damage.

22. A method to treat a skin disorder or promote healthy aging of skin, comprising applying to a dermal substrate a therapeutically effective amount of the compound of claim 1, to a subject in need thereof.

23. The method of claim 22, wherein the dermal substrate is human skin.

24. A method of treating a subject with evolving myocardial infarction comprising: administering a therapeutically effective amount of the compound of claim 1 to a subject in need thereof.
